(19) United States
(12) Patent Application Publication
(10) Pub. No.: US 2012/0309417 A1
(43) Pub. Date: Dec. 6, 2012

(54) METHOD AND APPARATUS FOR FACILITATING LOCATION BASED INTERACTION OVER AN AD-HOC MESH NETWORK

(75) Inventors: Jan Otto Blom, Lutry (CH); Gian Paolo Perrucci, Lausanne (CH)

(73) Assignee: Nokia Corporation, Espoo (FI)

(21) Appl. No.: 13/483,935

(22) Filed: May 30, 2012

Related U.S. Application Data
(60) Provisional application No. 61/491,748, filed on May 31, 2011.

(51) Int. Cl. H04W 24/00

(52) U.S. Cl. 455/456.1

(57) ABSTRACT

An approach is provided for enabling location based interaction between wireless nodes over an ad-hoc mesh network. A location anchoring services module monitors an ad-hoc mesh network for activity information exchanged among one or more nodes within a predetermined proximity. Messages exchanged between wireless nodes are then processed with respect to location information for determining a location anchor. The activity information are then associated with the location anchor.

### RELATED APPLICATIONS

This application claims the benefit of the earlier filing date under 35 U.S.C. §119(e) of U.S. Provisional Application Ser. No. 61/491,748 filed May 31, 2011, entitled “Facilitating Location Based Interaction over an Ad-Hoc Mesh Network,” the entirety of which is incorporated herein by reference.

### BACKGROUND

Wireless (e.g., cellular) service providers and device manufacturers are continually challenged to deliver value and convenience to consumers by, for example, providing compelling network services, applications, and content. One area of development is the use of device-to-device communication networks and devices to automatically determine information and context about the local environment. However, technical challenges relating to power consumption, signaling overhead, security, and privacy have hindered such development. Furthermore, services for supporting the real-time interaction of both local and remotely located based on activity determined to occur within a local device-to-device communication network are limited.

### Some Exemplary Embodiments

Therefore, there is a need for an approach for enabling location based interaction between wireless nodes over an ad-hoc mesh network.

According to one embodiment, a method comprises causing, at least in part, a monitoring of an ad-hoc mesh network for activity information exchanged among one or more nodes within a predetermined proximity. The method also comprises processing and/or facilitating a processing of location information associated with the activity information, the one or more wireless nodes, or a combination thereof to determine at least one location anchor. The method further comprises causing, at least in part, an association of the activity information with the at least one location anchor.

According to another embodiment, an apparatus comprising at least one processor, and at least one memory including computer program code for one or more programs, the at least one memory and the computer program code configured to, with the at least one processor, cause the apparatus to cause, at least in part, a monitoring of an ad-hoc mesh network for activity information exchanged among one or more nodes within a predetermined proximity. The apparatus is also caused to process and/or facilitate a processing of location information associated with the activity information, the one or more wireless nodes, or a combination thereof to determine at least one location anchor. The apparatus is further caused to associate the activity information with the at least one location anchor.

According to another embodiment, a computer readable storage medium carrying one or more sequences of one or more instructions which, when executed by one or more processors, cause an apparatus to monitor an ad-hoc mesh network for activity information exchanged among one or more nodes within a predetermined proximity. The apparatus is also caused to process and/or facilitate a processing of location information associated with the activity information, the one or more wireless nodes, or a combination thereof to determine at least one location anchor. The apparatus is further caused to associate the activity information with the at least one location anchor.

According to another embodiment, an apparatus comprises means for causing, at least in part, a monitoring of an ad-hoc mesh network for activity information exchanged among one or more nodes within a predetermined proximity. The apparatus also comprises means for processing and/or facilitating a processing of location information associated with the activity information, the one or more wireless nodes, or a combination thereof to determine at least one location anchor. The apparatus further comprises means for causing, at least in part, an association of the activity information with the at least one location anchor.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a communication system capable of enabling location based interaction between wireless nodes over an ad-hoc mesh network, according to an exemplary embodiment;

FIG. 2A is a diagram of the components of a wireless node including an awareness services module, according to an exemplary embodiment;

FIGS. 2B-2E are diagrams of the components of an awareness services module, according to various exemplary embodiments;

FIG. 2F is a diagram of the data structure of a network layer message header, according to an exemplary embodiment;

FIG. 2G is a diagram depicting a power saving scheme of a device-to-device radio layer, according to an exemplary embodiment;

FIGS. 3A-3D are flowcharts of processes for enabling location based interaction between wireless nodes over an ad-hoc mesh network, according to various exemplary embodiments;

FIGS. 4A and 4F are diagrams of a user interfaces utilized in the process of enabling location based interaction between wireless nodes over an ad-hoc mesh network, according to various exemplary embodiments;

FIGS. 5A-5C are diagrams depicting a process of enabling location based interaction between wireless nodes over an ad-hoc mesh network, according to an exemplary embodiment;

FIGS. 6A-6B are diagrams of a user interface utilized in the process of locating communities over an ad-hoc mesh network, according to various exemplary embodiments

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF PREFERRED EMBODIMENT

A method and apparatus for enabling location based interaction between nodes are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Awareness information may include, for example, any information and/or context about a local environment as well as the users and communication devices within the local environment. By way of example, awareness information can be used to support applications for creating social networks, determining presence or location, determining contexts associated with a device, advertising, searching for information, etc. Although various exemplary embodiments are described with respect to providing awareness information over an ad-hoc mesh network, it is contemplated that the approach described herein may be used within any type of communication system or network.

Also, location information may include, for example, any information for indicating the location of a user, node or other item within a given environment. By way of example, location information may be determined based on global positioning system (GPS) techniques, local positioning system (LPS) techniques, or a combination thereof. The location information may be determined in connection with awareness information for one or more nodes whose location and/or presence is required for supporting mutual interaction within a given proximity. By way of example, the location information may be determined, generated or presented in the form of specific coordinates indicating a geographic reference point for a given item, as a map generated in accord with a mapping application, as a text based description such as a postal address location, or a combination thereof. As will be discussed further later on, location information may be analyzed and/or processed with respect to activity information exchanged within a local environment (based on awareness information), such as relative to a location anchor.

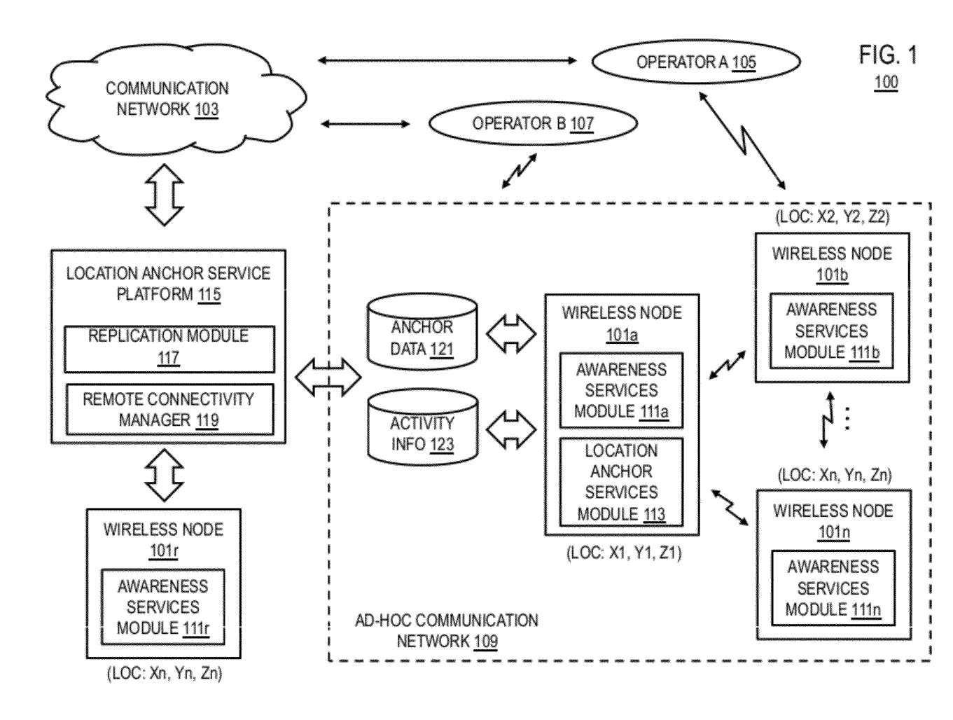

FIG. 1 is a diagram of a communication system capable of enabling location based interaction between wireless nodes over an ad-hoc mesh network, according to an exemplary embodiment. Information and context comprise “awareness information” that metaphorically equip a communication device with “radio eyes and ears” to continuously collect and exchange information with other devices in a local environment. However, development of a system for providing awareness information poses significant technical challenges, particularly in the areas of creating a network for sharing awareness information, locating and organizing awareness information, forming communities for sharing awareness information, managing power consumption for devices constantly engaged in sharing awareness information, developing applications to take advantage of the awareness information, maintaining the privacy and anonymity of users sharing awareness information, and preventing the proliferation of undesired messages (e.g., spam) over the network. Moreover, mechanisms for extending awareness information beyond a local environment for supporting the ability of remote wireless nodes 101 to engage in local information exchange are limited.

To address this issue, FIG. 1 presents a system that processes location information and activity information exchanged by one or more wireless nodes 101 as awareness information. This data is then used to determine a common location of the nodes, which is subsequently stored by the system as a location anchor. A location anchor may include, for example, a reference location point such as a store, building, park, residence or geographic area. Location anchors may be represented graphically, for example, in connection with mapping information to correspond to a particular point or area on the map to varying degrees of granularity. In certain embodiments, at least one of the one or more wireless nodes 101a-101n is equipped with a location anchor services module 113 that interacts with an awareness services module 111a active upon each of the respective wireless nodes 101a-101n for supporting the association of location information with activity information exchanged between wireless nodes 101a-101n. Activity information exchange is performed pursuant to joint communication or interactivity between wireless nodes 101a-101n relative to a predetermined geographic proximity (e.g., within a local range of connectivity). Activity information may include, for example, data regarding activities and interactions between multiple nodes, including messaging activity, file exchange, gaming, etc, by way of one or more applications at respective nodes.

In certain embodiments, wireless nodes 101a equipped with a LASM 113 may store location anchors in an anchor database 121. The location anchor services module 113 calculates the geographic reach of locally based activities occurring between respective wireless nodes 101a-101n based on the position (e.g., X, Y, Z coordinates) of each of the wireless nodes 101 engaged in the activity information. By way of example, the LASM 113 of wireless node 101a queries the other wireless nodes 101b-101n for location information pertaining to the wireless nodes 101b-101n respectively. Once collected by the LASM 113, this location information is compared with the reach/bounds of pre-existing location anchors as stored in the anchor database 121 for determining if it conforms to a pre-existing location anchor. If a location anchor is identified from the anchor database 121 that matches the reach of the present ad-hoc mesh network 109 to a certain predefined level of precision, that particular location anchor is determined to be associated with the local activity occurring between interacting wireless nodes 101. Should no pre-existing location anchor be identified based on collecting location information for interacting wireless nodes 101, a new location anchor can be constructed by the LASM 113. Location anchors may be defined based on the geographic dimensions of the present ad-hoc mesh network 109 activity, known map information, message content as exchanged by respective wireless nodes 101a-101n, news feed data, communication with other wireless nodes 101, etc. For example, when the geographic coordinates of wireless nodes 101a-101n are determined to differ from existing anchor data, a new anchor may be stored as “Downtown Train Station” based on a cross referencing of map data, location information and a detection of a wireless access point signal (handshake) of the train station.

While the LASM 113 facilitates local wireless node 101 activity information, a location anchor service platform 115 is configured to facilitate the connectivity of one or more remotely located wireless nodes with those located within the predetermined geographic proximity. By way of example, it is assumed that wireless nodes 101a-101n correspond to location coordinates X1, Y1, Z1 through Xn, Yn, Zn, respectively. These coordinates are within a predetermined range of connectivity—i.e., a range suitable for supporting ad-hoc mesh network 109 communications among these nodes. Wireless node 101r, also equipped with an awareness services module 111r and optional LASM corresponds to location coordinates Xr, Yr, Zr. These coordinates are outside the range of connectivity with wireless nodes 101a-101n via the ad-hoc mesh network 109. Under this scenario, local wireless nodes 101a-101n may readily exchange awareness information between one another and engage in interactive communication activities, such as social networking, meeting collaborations, etc., over the ad-hoc mesh network 109. This local connectivity is mediated by the LASM 113 of wireless node 101a, which records the various activity information exchanged between wireless nodes 101a-101n in reference to the location anchor to a activity information database 123.

In certain embodiments, the LASM 113 transmits the recorded current and past activity information exchanged between local wireless nodes 101a-101n to a location anchor service platform 115. For example purposes, the activity information database 123 maintained by the LASM 113 is shown as being accessible by the location anchor service platform 115. In certain embodiments, however, the anchor data and activity information data may be replicated by the LASM 113 and subsequently maintained by another anchor database and activity information database that is directly accessible to the location anchor service platform 115. By way of this approach, a replication module 117 may be employed by the location anchor service platform 115 for managing, in connection with the LASM 113, consistent updating of data. The techniques presented herein contemplate any known data mining, data sharing or data exchange approach.

To facilitate remote wireless node 101r access to the local activity, the wireless node 101r accesses the location anchor service platform 115 via communication network 103. This may include a registration and/or login process with a service provider—i.e., the same service provider that enables the LASM 113 to be enabled on one or more wireless nodes 101. Once accessed, the recorded activity information is made available to the remote wireless node 101r when it references the same location anchor, and thus activity, to which the activities are correlated. As such, the location anchor service platform 115 serves as an intermediary or proxy service that enables the remote wireless node 101r to interact with local wireless nodes 101a and 101b in a manner as if the wireless node 101r was positioned within range of the ad-hoc mesh network 109. Messages, files, transaction data, and other activity information exchanged by the remote wireless node 101r for interacting with wireless nodes 101a-101n are relayed between the location anchor service platform 115 and the LASM 113. It is noted, therefore, that the LASM 113 serves a dual function, which includes: (1) persistently uploading activity information exchanged between one or more local wireless nodes 101a-101n to the location anchor service platform 115 as they interact with respect to a common location anchor, and (2) persistently uploading activity information generated by the one or more remote wireless nodes 101r as they interact with local wireless nodes 101a-101n based on the same location anchor.

For the purpose of illustration with respect to the above described operation of the LASM 113 and the location anchor service platform 115, awareness information exchange may be taken to be synonymous with the exchange of activity information among wireless nodes 101 within a predetermined proximity. Thus, the above described activity information between the location anchor service platform 115 and LASM 113 is facilitated by, includes, or is based upon the exchange of awareness information between interacting remote wireless node 101r and/or local wireless nodes 101a-101n. While shown as separate components, the LASM 113 may be optionally integrated within the awareness services module 111a in certain embodiments.

The one or more wireless nodes 101a-101r optionally has connectivity to a communication network 103 through either operator A 105 or operator B 107. The wireless nodes 101a-101r are any type of mobile terminal, portable terminal, or fixed terminal including mobile handsets, personal computers, stations, units, devices, multimedia tablets, Internet nodes, communicators, Personal Digital Assistants (PDAs), radio readable tags (e.g., near field communication (NFC) tags, radio frequency identification (RFID) tags), or any combination thereof. It is also contemplated that the wireless nodes 101a-101r can support any type of interface to the user (such as “wearable” circuitry, etc.).

In exemplary embodiments, the wireless nodes 101a-101n form an ad-hoc mesh network 109 for exchanging activity information. The ad-hoc mesh network 109 is, for instance, a connectionless and serverless device-to-device network (e.g., a mobile ad-hoc network (MANET)) created using short-range radio technology (e.g., wireless local area network (WLAN) or Bluetooth®). Within the ad-hoc mesh network 109, each wireless node 101 may be mobile and is within communication range of any number of other wireless nodes 101. Accordingly, the set of wireless nodes 101a-101n that is within communication range of any a particular wireless node 101 is transient and can change as the wireless nodes 101a-101n move from location to location. It is noted that the ad-hoc radios (e.g., WLAN and Bluetooth®) may be designed to support connectivity (e.g., connectivity via Internet protocol (IP)) among wireless nodes 101 with respect to various applications and services accessible to the device. The applications and services may enable the exchange of awareness information for supporting shared interaction and activity information exchange among the wireless nodes 101a-101n.

Also, of note, the system 100 creates the ad-hoc mesh network 109 for exchanging messages in a connectionless fashion. As used herein, the term “connectionless” refers to the ability of a node (e.g. wireless node 101a) to send and of all surrounding wireless nodes 101a-101n to receive messages, such as in the context of a defined application (e.g., game, social networking activity, alert system) without the need to send any prior control signaling. For example, sending messages using the transmission control protocol/IP (TCP/IP) over a WLAN ad-hoc is not connectionless because of the two-way TCP control signaling between the sending and receiving nodes used to establish the TCP connection. Awareness information is provided, for instance, in small anonymous messages that are exchanged by the wireless nodes 101a-101n automatically without user intervention. As used herein, the term “anonymous” means that it is not possible to infer the true identity of the sender from the message, unless the true identity is intentionally included in the message (e.g., by the user or another entity authorized by the user).

The exchange of awareness information occurs as a broadcast message (i.e., a flooding message) from a wireless node 101 to neighboring wireless nodes 101 that are within range of the radio of the broadcasting wireless node 101. As neighboring wireless nodes 101 receive the broadcasted message, each receiving wireless node 101 may in turn rebroadcast the message to other neighboring wireless nodes 101. In this way, the originally broadcasted message propagates throughout the ad-hoc mesh network 109. In exemplary embodiments, the extent of the propagation may be limited by criteria such as distance, location, time, etc. Also, in certain embodiments, the extent of propagation may be limited to a determined depth or width (e.g., size) of a hierarchy of a location anchor, wherein the size of the hierarchy indicates a level or scale of activity information occurring respective to a given location.

Unlike traditional systems, broadcast messages are only for carrying awareness information and are not for transporting content (e.g., files or media containing voice, video, etc.) between two wireless nodes (e.g., wireless nodes 101a and 101b). Instead, the messages contain only pointers to the content or a small amount of data (e.g. presence or context information) to minimize the data traffic transported over the ad-hoc mesh network 109. The wireless nodes 101a-101n may then access the content using other communication channels (e.g., via IP through the communication network 103). By way of example, content such as text, graphics, media or other data may be accessed for enabling activity information exchange between one or more nodes in support of a social networking application, gaming application, group training application or the like.

In addition, the system 100 eliminates the problems associated with traditional methods for route establishment and maintenance (e.g., connection based communication protocols), such as maintaining and handing off connections as mobile devices move, and requiring high levels of network resources for maintaining connections in an environment with a high number or density of mobile devices. For example, the event of a wireless node 101 appearing/disappearing to/from the network does not generate any control signaling in the ad-hoc mesh network 109. Similarly, the system 100 creates routing information only when needed to route replies to queries back to the querying node. The routing information is generated by using the query messages alone (i.e. no control signaling is used for creating routing information). After the query and subsequent reply process is completed, the routes are forgotten. Hence, the query/reply process of the system 100 provisions routes for a reply to provide awareness information on demand rather than pushing awareness information from one wireless node 101 to another. In exemplary embodiments, both push (e.g., information is published over the ad-hoc mesh network 109) and pull (e.g., information is queried from other wireless nodes 101a-101n of the ad-hoc mesh network 109) modes of disseminating awareness information are possible. In certain embodiments, it is contemplated that the pull mode of operation can be used instead of the push mode to help suppress potential spam messages.

Moreover, the system 100 optimizes the power consumption of wireless nodes 101 communicating over the ad-hoc mesh network 109 to enable always-on operation without seriously affecting the battery life of the wireless nodes 101. In addition, the system supports the interaction of remotely connected wireless nodes 101r with those engaged via an ad-hoc mesh network 109. For instance, by utilizing only short awareness messages, by eliminating the need for any route maintenance signaling, by employing procedures to minimize transmission and reception of duplicative messages and by enabling an efficient sleep scheme for the short-range device-to-device radio used within each wireless node 101 (allowed by the low latency requirements typical of an awareness information network), the system 100 can potentially provide hundreds of hours (e.g., over 400 hours) of continuous operation of each wireless node 101 between battery charges in a mobile device. The system 100 could be seen as a “nervous system” between the mobile devices, where small messages (“nerve impulses”) are continuously exchanged by the mobile devices (“neurons”) in order to bring awareness to the user of a mobile device about the user's surroundings.

As another power consumption and data usage feature, the wireless nodes 101 may interact with one another based on location information to support shared balancing of bandwidth required for supporting the interaction. By way of example, when awareness information is exchanged to support execution of a gaming application among wireless nodes 101a-101n, the constant amount of messages transmitted to support the activity may be distributed among the nodes equally. Load distribution may be based, in part, on a hierarchical scale of the location anchor that serves as a reference point for the activity information. The location anchor may, for instance, be scaled hierarchically to support member drop out or join in during an engaged activity. The scaling may also be presented as an icon, rating or value for presentment to the one or more nodes engaged in the activity for promoting increased participation of wireless nodes 101 and thus, increased load sharing and more optimal energy consumption per wireless node 101.

In certain embodiments, the location anchor service platform 115 is configured with a remote connectivity manager 119 that determines the bandwidth demands of one or more remotely connected wireless nodes 101r for optimal engagement in activity information with the wireless nodes 101a-101n connected to ad-hoc mesh network 109. By way of example, the remote connectivity manager 119 may present the LASM 113 of wireless node 101a with connectivity data such as the number of remote wireless nodes 101r attempting to or currently accessing the activity, network conditions that may impact activity performance (e.g., server loss, high traffic), location based data restrictions and rules (e.g., international data rates versus domestic), etc. This information may also be used, at least in part, for impacting load distribution among wireless nodes 101 per the above described hierarchical scaling.

The system 100 also enables the development of new services and applications based on awareness information (e.g., social networking applications, location-based applications, application for determining presence, applications for determining context, advertising applications). In particular, the continuous and immediate nature of the awareness information with respect to local environment enables compelling new services. For instance, awareness information may be combined with the increasingly available storage and computing power in mobile devices (e.g., wireless nodes 101) to create local semantic group interactions, whereby local awareness information is exchanged to support peer-to-peer based applications automatically by wireless nodes 101 within the ad-hoc mesh network 109. As used herein, the term “semantic group interactions” refers to a system in which the information and messages shared is understandable by the wireless nodes 101 within the system. The system 100 can also be used for collaborative context calculation, publishing pointers to information or content, search for friends within a defined community, finding out what is going on and what kind of people are around a user, making the environment aware of the user, and other like applications.

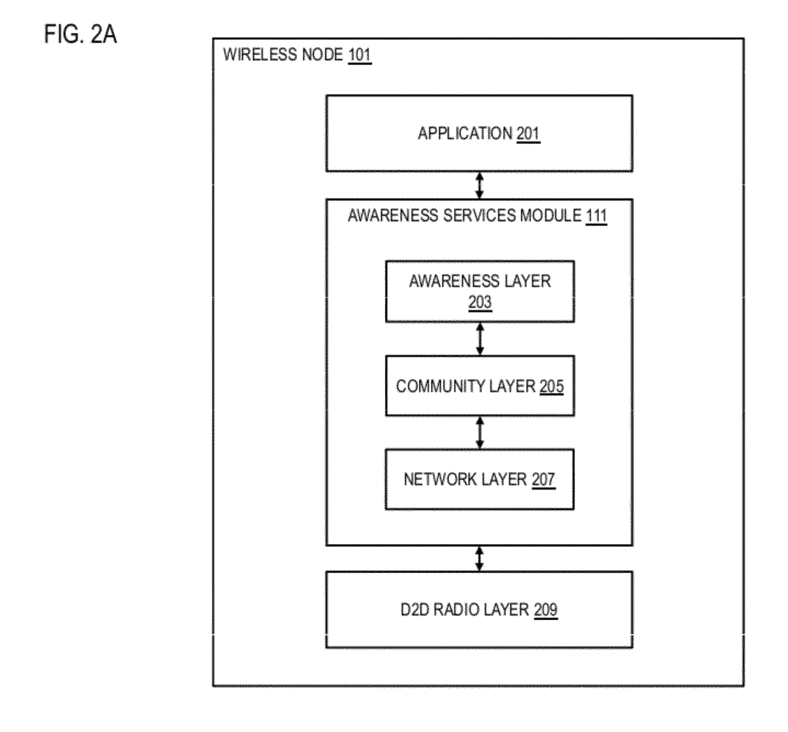

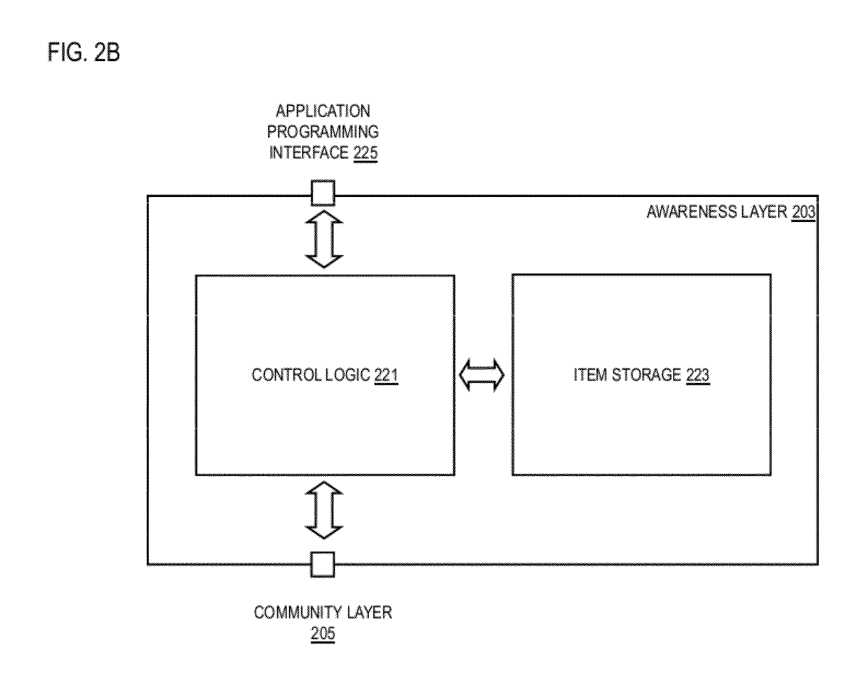

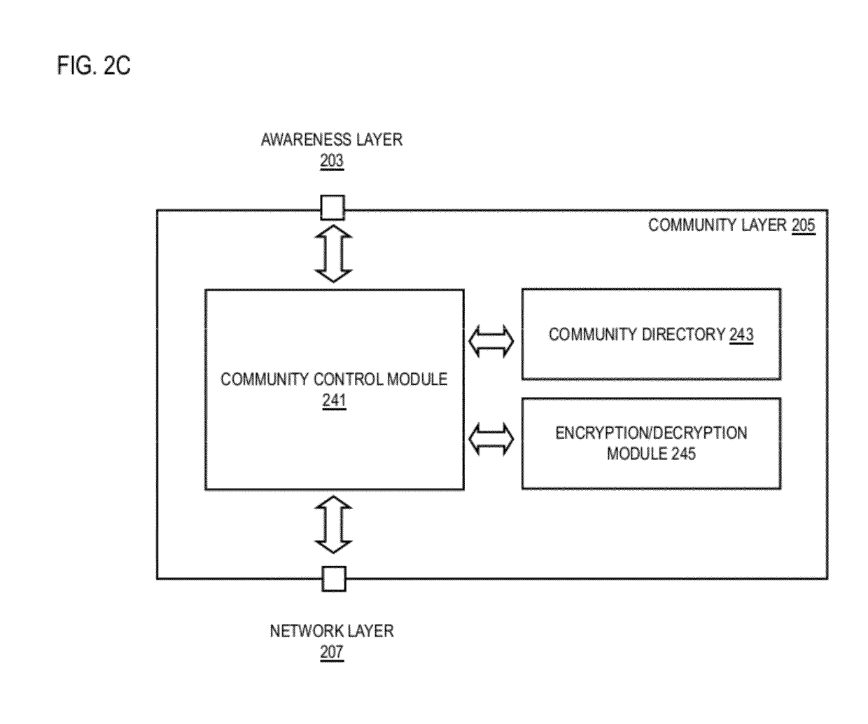

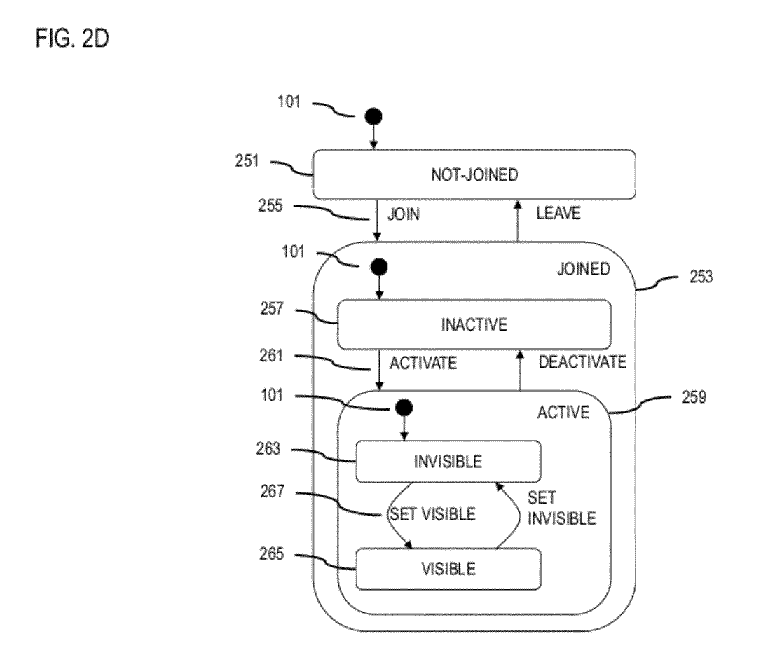

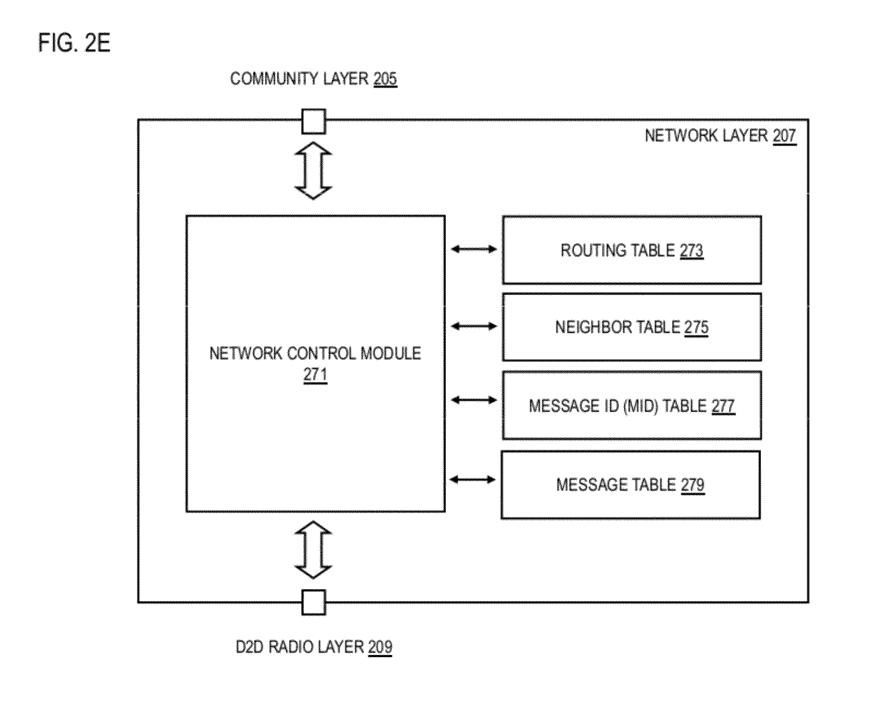

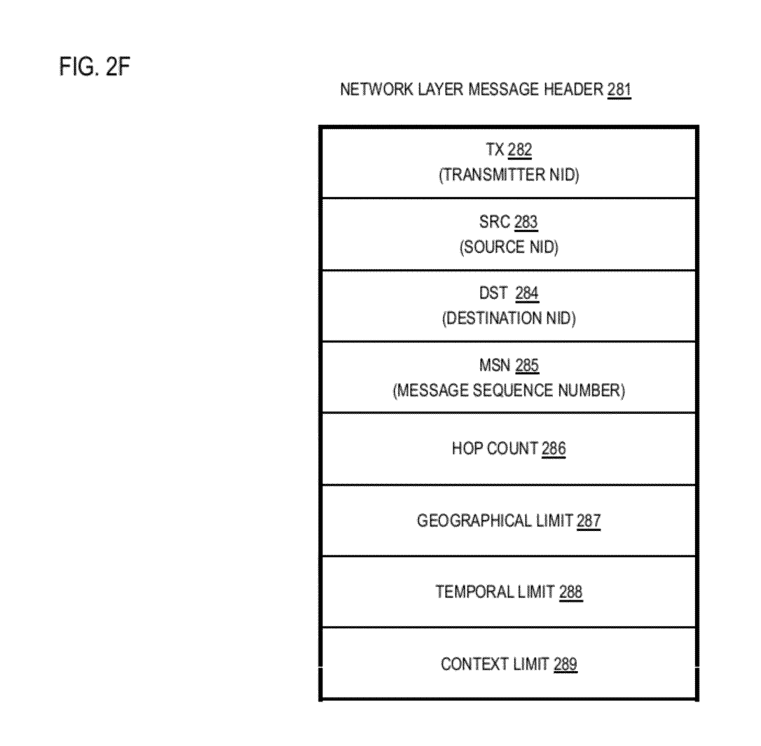

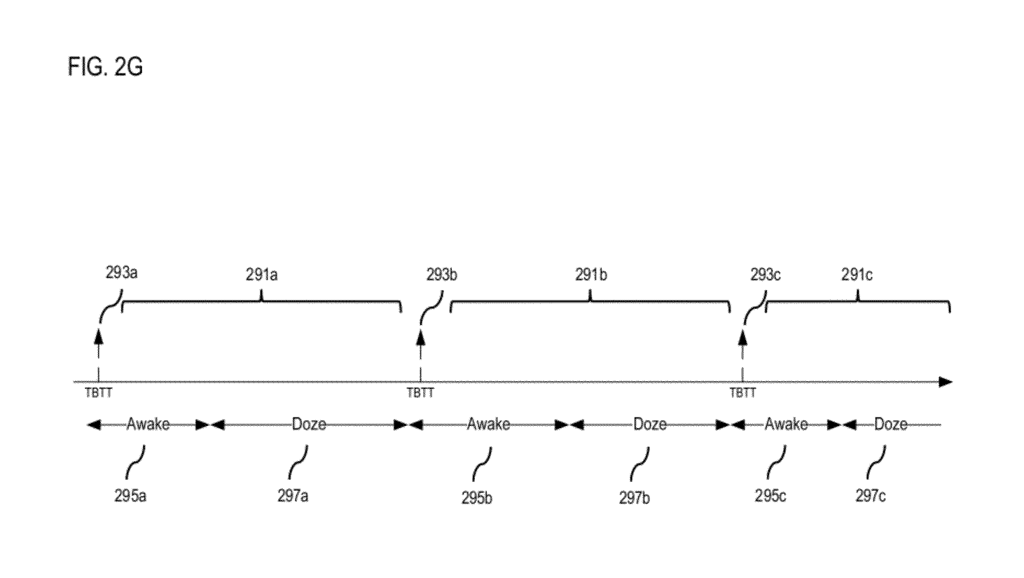

FIG. 2A is a diagram of the components of a wireless node including an awareness services module, according to an exemplary embodiment. FIG. 2A is described with respect to FIGS. 2B-2E which are diagrams of the components of an awareness services module, according to various exemplary embodiments. Although not shown, the LASM 113 may also be integrated with the awareness services module 111a in certain embodiments. It is noted that the integration and/or interaction of these modules merges the capabilities of the awareness services module 111 with the location anchoring and remote connectivity management capabilities of the LASM 113.

In FIG. 2A, a wireless node 101 includes one or more components for sharing awareness information within the ad-hoc mesh network 109. It is contemplated that the functions of these components may be combined in one or more components or performed by other components of equivalent functionality. In this embodiment, the wireless node 101 includes an application 201 that uses awareness information to provide various services and functions including social networking, location-based services, presence information, context determination, advertising functions, etc. The application 201 may interact with the awareness services module 111 to obtain or share awareness information.

By way of example, the awareness services module 111 includes three layers: a cognition layer 203, a community layer 205, and a network layer 207. The cognition layer 203 is the highest control layer for sharing awareness information. As shown in FIG. 2B, the cognition layer 203 includes a control logic 221 and item storage 223. The control logic 221, for instance, provides the logic for creating, publishing, querying, and receiving awareness information over the ad-hoc mesh network 109. The control logic 221 can store the information that it either creates or receives in the item storage 223. It is contemplated that the item storage 223 may be of sufficient size to store all or a portion of the information that flows through the wireless node 101 over a configurable period of time (e.g., days, months, or years).

In exemplary embodiments, the control logic 221 enables querying and dissemination of awareness information by initiating the flooding of the query or information to neighboring wireless nodes 101 within the ad-hoc mesh network 109. For example, upon receiving a query, the wireless nodes 101 in the local neighborhood that have the queried information reply to the querying node automatically. In exemplary embodiments, the reply information is also automatically stored in the item storage 223 of each wireless node 101 through which the propagating reply passes. Moreover, the reply to a query may result in return of a pointer to specific content relevant to the query rather than the content itself under certain circumstances (e.g., when the specific content is large in size). It is contemplated that the reply may contain direct content if the content is relatively small (e.g., a few tens of bytes of information). By using a pointer, the system 100 minimizes the data traffic that flows through the ad-hoc mesh network 109. The user may then access the content via the pointer (e.g., a universal resource locator (URL) address, IP address) via a more appropriate communication protocol (e.g., IP) and/or means of communication (e.g. infrastructure networks). The receipt of the pointer (e.g., IP address) may automatically trigger the transfer of the content using, for instance, the communication protocol associated with the pointer. In the case of broadcasting or publishing information, any wireless node 101 through which the published information propagates may store the information in item storage 223 of the wireless node 101.

In other exemplary embodiments, awareness information can also be published directly by flooding an awareness message. Such a push mode for the dissemination of awareness information can be used to support some applications (e.g. advertising or group chatting) over the ad-hoc mesh network 109.

It is recognized that privacy and anonymity may be of concern to users of the system 100. Accordingly, the control logic 221 provides mechanisms for ensuring privacy and anonymity. For example, the control logic 221 can prevent the transmission of intimate information when the number of neighboring wireless nodes is small to prevent the possibility of inferring identity. As used herein, the term “intimate information” refers to information directly related to the user, e.g., the user's habits, tastes, or preferences (musical preferences, favorite restaurants, etc.).

The control logic 221 may also periodically broadcast decoy queries and replies to make tracking an individual wireless node 101 more difficult. Since an outside observer does not know the authentication key associated with a community, the observer cannot distinguish a valid message from a fictitious one. Accordingly, by observing decoy messages, the observer is likely to detect presence of a private community when there is not one. Additionally, the control logic 221 enables to user to define filters for incoming information (e.g., filter advertisements) and how these filters would work (e.g., ignore the information completely, relay the information but do not store, etc.). It is also contemplated that the user can direct the control logic 221 to control the user's visibility on the ad-hoc mesh network 109 (e.g., no visibility, visible only to a certain community or other user) to maintain privacy. As another mechanism for protecting privacy, the control logic 221 can interact with the community layer 205 to anonymize a specific message and corresponding identifiers as described below with respect to the community layer 205.

Because one of the goals of the system 100 is to provide a mechanism for anonymous spreading of awareness information, it is recognized that undesired or unsolicited messages (e.g., spam messages) may become a problem. To address this problem, the control logic 221 may obtain, for instance, information from the lower system layers of the awareness services module 111 about the traffic load and current average power consumption. If the traffic load is medium or high (meaning that also power consumption related to the system 100 is medium or high) restrictions may be set for the frequency at which flooding messages are sent by the control logic 221. It is also contemplated, that the neighboring peer wireless nodes 101 can be configured to not forward any flooding messages originating from a wireless node 101 neglecting such message restrictions.

The cognition layer 203, together with the community layer 205, provide an application programming interface (API) 225 to enable an application 201 to access the functions of the control logic 221 and the item storage 223. In exemplary embodiments, the API 225 enables application developers to have uniform and easy access to functions related to sharing awareness information over the ad-hoc mesh network 109. It is contemplated that the API 225 is extensible to accommodate any application designed to access or use awareness information. The applications in the various wireless nodes 101 do not have to be the same or mutually compatible. It is sufficient that the applications use the API correctly to be able to publish and search awareness information in the surrounding wireless nodes 101.

The cognition layer 203 also has connectivity to the community layer 205. The community layer 205 controls the formation and cataloging of communities of wireless nodes 101 within the ad-hoc mesh network 109. By way of example, a user may create any number of communities for sharing awareness information. It is contemplated that a community may be either a peer community (e.g., any wireless node 101 may join), a personal community (e.g., a wireless node 101 may join only if invited), or the open local community that consists of all nodes in the local neighborhood. In exemplary embodiments, the messages that traverse between the wireless nodes 101 within the ad-hoc mesh network 109 belong to one of these three community types. Communities can either be private (messages are encrypted) or public (no encryption used). In exemplary embodiments, membership and status in a community affect how the wireless node 101 shares awareness information (see the discussion with respect to FIG. 2G for additional details of community membership).

Furthermore, a community may be created for any purpose or duration (e.g., a permanent work community, a permanent community of friends, a temporary community of concert goers lasting only the duration of the concert). As shown in FIG. 2C, the community layer 205 includes a community control module 241, a community directory 243, and an encryption/decryption module 245. The community control module 241 provides the logic for creating, joining, managing (e.g., updating membership, configuring settings and preferences, setting privacy policies), and deleting communities. The community control module 241 also provides part of the API 225.

In exemplary embodiments, the community control module 241 assigns a unique community identification number (CID) to each community for use within the ad-hoc mesh network 109. The community control module 241 can also generate authentication keys K associated with the CID to, for instance, authenticate users who wish to join the community or authenticate messages directed to the community. For example, a wireless node 101 may invite another wireless node 101 to join a community by transferring the CID and authentication keys associated with the community to the other wireless node 101. It is contemplated that the transfer of the CID and corresponding authentication key may occur using short range radio or using another secure mechanism (e.g., short message service (SMS) or electronic mail). It is noted that both peer and personal communities use a CID and corresponding K, whereas the open local community either can use a predetermined value for CID (e.g., zero) or does not use the CID at all.

To ensure privacy (as discussed above), the community control module 241 interacts an encryption/decryption module 245 to anonymize the CID when including the CID in messages over the ad hoc mesh network 109. For example, a wireless node 101 may direct a query to a specific community using an anonymized CID (e.g., a pseudonym) associated with the community in lieu of the actual CID. In exemplary embodiments, multiple anonymized CIDs may be used to represent a single community. In this way, it is more difficult to identify queries corresponding to a particular community by monitoring traffic within the ad hoc mesh network 109. From the perspective of an outside observer, the anonymized CIDs look random. In addition, the encryption/decryption module 245 may encrypt or decrypt message data using, for instance, a temporary key that is periodically derived from the authentication key K associated with the CID. These measures hinder the discovery of the CID by outsiders that do not have the authentication key. By way of example, the community layer 205 inserts a special header into the messages that it receives from the cognition layer 203. The special header, for instance, contains a list of anonymized community identifiers corresponding to the communities to which the message is relevant.

FIG. 2D is a state diagram of the effect of community membership and status on sharing awareness information, according to an exemplary embodiment. As shown in FIG. 2D, a wireless node 101 may be in either one or two states (e.g., a not-joined state 251 and a joined state 253) with respect to membership in a community within the ad-hoc mesh network 109. The application 201 of wireless node 101 issues, for instance, a command 255 to either join or leave a community to transition between the not-joined state 251 and the joined state 253. When the wireless node 101 is in the not-joined state 251 with respect to a community, the wireless node 101 has no information (e.g., CID and associated authentication keys K) about the community and cannot access messages directed to the community. When the wireless node 101 is in the joined state 253, the community layer 205 receives the CID and possibly one or more authentication keys associated with the community. In one embodiment, authentication keys are provided when membership in the community is by invitation or otherwise restricted (e.g., when the community is a personal community or a private community). Accordingly, the community layer 205 will be able to encrypt outgoing community specific messages and to decrypt incoming community specific messages.

When the wireless node 101 is in the joined state 253, the wireless node 101 may also be in either an inactive state 257 or an active state 259. To transition between the inactive state 257 and the active state 259, the application 201 may issue a command 261 to either activate or deactivate the joined state 253 via the application programming interface 225. When the wireless node 101 is in the inactive state 257, the community layer 205 abandons the message even though it is a member of the community. In certain embodiments, the wireless node 101 may also be invisible to other members of the community while in the inactive state 257. For example, the wireless node 101 may enter the inactive state 257 when it temporarily does not want to receive or share information with the community. When the wireless node 101 is in the active state 259, the community layer 205 encrypts and decrypts community messages as usual for private communities, and enables all outgoing and incoming community specific messages for public communities (e.g., communities with no restrictions on membership).

Within the active state 259, the wireless node 101 may also be in either an invisible state 263 or a visible state 265. To transition between the invisible state 263 and the visible state 265, the application 201 issues a command 267 to set either the visible or invisible state. When in the invisible state 263, the community-specific identity (e.g., a user alias) associated with the wireless node 101 cannot be queried by other members of the community. For example, in the invisible state 263, the community layer 205 continues to receive and send community messages without its identity known to other community members. When in the visible state 265, the identity of the wireless node 101 can be queried by other members of the community.

In various embodiments, the community directory 243 of the community layer 205 maintains, for instance, information on the communities that the user has joined. Such information contains, at least, the community identification (CID). Additionally, it may contain public and/or private authentication keys (K) of the joined communities and a list of anonymized community identifiers for each community. The community control module 241 may periodically recalculate the list of anonymized CIDs. By way of example, the community layer 205 inserts a header into the message it receives from the cognition layer 203. The header contains, for instance, a list of anonymized community identifiers identifying the communities to which the message is relevant.

It is contemplated that a special personal community can be reserved for tracking new bonds or relationships created between users. Consider, for example, that user A meets user B for the first time and wants to create a radio bond between the mobile devices corresponding to each user. In one embodiment, user A can initiate the creation this bond with user B by transferring to user B (e.g., by using a secure transfer mechanism) the CID and the public K of user A's personal “new bonds” community. Similarly, user B may give user A similar credentials corresponding to user B's “new bonds” community. Once the credentials are exchanged and the bond has been created, user A may find user B over the ad-hoc mesh network 109 by searching for members of user A's “new bonds” community. In other words, with a simple search of a single community, user A can search for all the people in user A's local neighborhood with whom she has created a bond. This requires that a high number of community CIDs and Ks can be stored in the community directory 243. Also, an effective lookup of the community directory must be provided. There are many existing and good solutions for such efficient lookup.

As the user creates new bonds, the number community CIDs and Ks stored in the user's community directory 243 can grow quite large. Accordingly, to enable effective search of a large number of communities, the community layer 205 may generate a special community search message to initiate the search. For example, the special community search message contains, at least in part, a list of anonymized community identifiers corresponding to the communities to be searched. To protect the privacy, the community layer 205 can generate a new set of anonymized community identifiers for each community search message. If the community layer 205 finds a match to any of the anonymized community identifiers in any of the neighboring wireless nodes 101 that receives the search message, the community layer 205 generates a reply message that may contain the alias of the user in that community or other community specific information. The reply message may be encrypted with the encryption key of the community.

As shown in FIG. 2C, the community layer 205 has connectivity to the cognition layer 203 above and the network layer 207 below. The network layer 207 manages the rebroadcasting of received flooding messages and the routing of the unicast (typically reply) messages received by the wireless node 101. FIG. 2E depicts a diagram of the components of the network layer 207, according to an exemplary embodiment. The network layer 207 includes a network control module 271, routing table 273, neighbor table 275, message identification (MID) table 277, and message table 279. The network control module 271 directs the broadcasts of messages and information by managing and updating the routing table 273, neighbor table 275, MID table 277, and message table 279. In certain embodiments, the network control module 271 may also assist in protecting the privacy and anonymity of users by periodically changing the network layer identification associated with the wireless node 101. It is noted that making such a change in the network layer identification between queries does not cause routing problems for replies because the routing information is recreated by each query in the ad-hoc mesh network 109.

In exemplary embodiments, the network layer 207 may insert a header into messages it receives from the community layer 205 to, for instance, direct flooding and routing of the received messages. The structure of this network layer message header 281 is discussed with respect to FIG. 2F. FIG. 2F is a diagram of the data structure of a network layer message header, according to an exemplary embodiment. As shown, the message header 281 contains the following fields: (1) a TX field 282 to identify the transmitter node ID (NID) of the last transmitting wireless node 101; (2) a SRC field 283 to identify the source node ID of the wireless node 101 that originated the message; (3) a DST field 284 to identify the destination source ID of the intended recipient of a unicast (reply) message (e.g., this field is give a value of zero when the message is a flooding messages); (4) a MSN field 285 to identify the message sequence number assigned by the source node; and (5) a hop count field 286 that is incremented by one by each wireless node 101 that transmits the message. In certain embodiments, the message header 281 may also contain the following optional fields: (6) a geographical limit field 287 to designate the extent of the physical over which the message is intended to propagate (e.g., the geographical limit field 287 may contain a geographical position of the source node and a maximum flooding radius from that position); (7) a temporal limit field 288 (e.g., the temporal limit field 288 may contain the time when the message becomes obsolete and should be dropped); and (8) a context limit field 289 that defines the context beyond which the message is not intended to propagate (e.g. a message related to a particular concert is not intended to extend beyond the concert venue).

Returning to FIG. 2E, the network layer 207 also contains a routing table 273. In exemplary embodiments, the routing table 273 contains a listing of the node identification number (NID) of the originating wireless node 101 (e.g., source NID) and the NIDs of the last known transmitters of the message. The purpose of the routing table is to enable the routing of the reply messages (e.g., unicast messages) back to the querying node that originated the query through a flooding message. As the message propagates through the ad-hoc mesh network 109, each subsequent wireless node 101 that receives the message adds the NID of the last transmitter to the routing table to record the next hop neighbor towards the source node. The source node is marked as the destination wireless node (DST) in the routing table. Also the message sequence number of the message is recorded. The update of the routing table 273 is coordinated by the network control module 271. As shown in Table 1, the routing table 273 lists the destination NID, the transmitter NIDs associated with wireless nodes 101 that have rebroadcasted a message and the MSN of the message.

TABLE 1

| Destination NID | Transmitter NIDs | Message Sequence Number |
|---|---|---|
| DST₁ | TX₁₁, TX₁₂, . . . , TX_{1M} | MSN₁ |
| DST₂ | TX₂₁, TX₂₂, . . . , TX_{2N} | MSN₂ |
| . . . | . . . | |
| DST_{S} | TX_{S1}, TX_{S}, . . . , TX_{ST} | MSN_{S} |

The neighbor table 275 contains a list of the neighboring wireless nodes 101 and an estimate of their relative radio distance (see Table 3). It is contemplated that the observed signal strength together with the known transmitting power of a neighboring wireless node 101 is an indicator of the proximity of the wireless node 101 and can be used to calculate the relative radio distance. The relative radio distance of the node from which the message was last received is then used as a criterion for whether or not the wireless node 101 retransmits a received message. For instance, higher signal strength indicates closer proximity to the wireless node 101. The network control module 271 monitors the signal strengths of neighboring wireless nodes 101 as the network control module 271 receives messages from nearby devices and uses it to estimate the relative radio distance (e.g., proximity of the transmitting wireless node 101). It is also contemplated that the network control module 271 may use any other mechanism for estimating the relative radio distance of neighboring nodes (e.g., estimating location using global positioning satellite receivers or other positioning techniques).

In certain embodiments, the network control module 271 uses the proximity information to direct the routing and transmission of messages over the ad-hoc mesh network 109. For example, the system 100 can reduce the potential, for overloading the ad-hoc mesh network 109 by implementing a smart flooding scheme whereby only a few wireless nodes 101 retransmit a flooding message. Whether a wireless node 101 retransmits a flooding message can be dependent on the relative distance group (e.g., “very near”, “near”, or “far”) to which the wireless node 101 that is the transmitter of the message belongs. More specifically, if the transmitting wireless node 101 is in the “far” or “near” group, the receiving wireless node 101 can retransmit the flooding message. If the transmitting wireless node 101 is in the “very near” group, the receiving wireless node 101 does not retransmit the flooding message. For each broadcast message received from a wireless node 101 in either the “far” or “near” group, the network control module 271 assigns a random delay time for relaying or rebroadcasting. The delay period, for instance, exhibits a distribution function based on the estimated relative radio distance as a way to randomize the delay period before transmission. The distribution should be chosen in such a way that the random delay is larger for those nodes that are “near” than for those that are “far.” This favors, for instance, wireless nodes 101 that are further away to relay the flooding message forward, which results in better flooding efficiency (smaller total number of transmissions). The use of a random delay time also prevents the unintended synchronization of message broadcasts as the message propagates over the ad-hoc mesh network 109. For example, unintended synchronization of the message broadcasts may result in too many wireless nodes 101 sending broadcasting (i.e., flooding) messages over the ad-hoc mesh network 109 at exactly the same time. Additionally, the delay time provides an opportunity for the network control module 271 to monitor and count rebroadcasts of the message by other neighboring wireless nodes 101.

TABLE 2

| Transmitter NID | Relative Radio Distance |
|---|---|
| TX₁ | D₁ |
| TX₂ | D₂ |
| . . . | . . . |
| TX_{T} | D_{T} |

The MID table 277 contains a list of received messages. As the wireless node 101 receives messages from neighboring nodes over the ad hoc mesh network 109, the network control module 271 uses the MID table to check whether the message has been received previously by, for example, comparing the MIDs in the MID table 277 to that of the received message. The MID table 277 also contains a flag indicating whether a message has been transmitted by the wireless node 101 and the time when the entry was last updated. In exemplary embodiments, the MID is the tuple (SRC, MSN), where SRC is the NID of the source node and MSN is a message sequence number assigned by the source node. In this way, the MID is a unique identifier of each message that propagates in the ad-hoc mesh network 109. The network control module 271 makes an entry in the MID table 277 for all new messages that it receives. If the message has been scheduled for transmission, the network control module 271 increments the message counter in the message table (see Table 4).

TABLE 3

| MID | Sent flag | Time of reception |
|---|---|---|
| (SRC₁, MSN₁₁) | “SENT” | t₁₁ |
| (SRC₁, MSN₁₂) | “NOT SENT” | t₁₂ |
| . . . | . . . | . . . |
| (SRC₂, MSN₂₁) | “NOT SENT” | t₂₁ |

The message table 279 contains messages that the network control module 271 has scheduled to transmit. For example, as the wireless node 101 receives a flooding message that the network control module 271 schedules for transmission, the network control module 271 updates the message table to include the message in the message table 279. Each entry in the message table 279 contains the message itself, the time when the message is scheduled to be sent, and the number of receptions of the same message by the wireless node 101 (see Table 4). In exemplary embodiments, a message is not relayed over the ad-hoc mesh network 109 if the number of times the message has been received exceeds a predefined limit. For example, a message has the initial count of 0. In this example, as a wireless node 101 in the neighborhood is observed to transmit the message, the message count associated with the message is increased. When the maximum message count is reached, the network control module 271 removes the message from the message table 279. The transmitter of each message is also associated with an estimated relative radio distance (D) indicating whether the transmitting wireless node 101 is within close proximity of the wireless node 101 (e.g., transmitting wireless node 101 is in the “very near” relative radio distance group) or far from the wireless node 101 (e.g., transmitting wireless node 101 is in the “far” relative radio distance group). If the relative radio distance associated with the transmitting wireless node 101 indicates that the transmission of the message occurred “very near,” the wireless node 101 would not have to relay the message because it is assumed, for instance, that most of the other neighboring wireless nodes 101 have already received the same message. By taking into account the relative radio distances of neighboring nodes, the described smart flooding functionality leads to, on average, each flooding message being received for a few times by each wireless node 101 independent of the node density. The number of times a message is received by any one wireless node 101 affects the scalability of the ad-hoc mesh network 109.

If the received message, however, is a unicast reply message that was addressed to the receiving wireless node 101, the network control module 271 checks whether the destination wireless node 101 can be found in the routing table 273 (e.g., can be found from the destination field in the reply message, or obtained from the source field of the query by the replying node). If found, the routing table entry will give the NID of the neighboring node to which the reply message will be sent in the next opportunity. If the unicast transmission is not successful, the next entry for the same DST will be used as the next try. If the received message is a unicast reply message that was not addressed to the receiving wireless node 101, and no acknowledgment from the intended receiver node was heard, the node will store the message in the message table 279 for scheduled retransmission. It is noted that unicast messages or acknowledgement messages that are not addressed to the wireless node 101 are normally received D2D radio layer 209 (see discussion of the D2D radio layer 209 below) but not by the awareness services module 111. However, under certain circumstances, the D2D radio layer 209 can provide such messages to the awareness services module 111 to schedule for retransmission. For example, if no successful unicast of the same message is observed by the time when the message is scheduled to be transmitted, the wireless node 101 will transmit the unicast or acknowledgement message to the intended recipient found from the routing table 273 associated with the message. In this way, the wireless nodes 101 that are not the intended recipients of the reply messages can assist in routing the message forward towards the correct destination.

TABLE 4

| Message | Time to send | Received msg count |
|---|---|---|
| MSG₁ | t₁ | C₁ |
| MSG₂ | t₂ | C₂ |
| . . . | . . . | . . . |
| MSG_{M} | t_{M} | C_{M} |

As shown in FIG. 2A, the awareness services module 111 has connectivity to a device-to-device (D2D) radio layer 209. The D2D radio layer 209 enables the formation of the ad-hoc mesh network 109 and sharing of awareness information using, for instance, short range radio technologies such WLAN and Bluetooth®. It is contemplated that the D2D radio layer 209 may use any wireless technology for communication between devices over short ranges. The radio technology, for instance, enables each wireless node 101 within the ad-hoc mesh network 109 to broadcast messages in a connectionless way to the neighboring wireless nodes 101 that are within radio range. As used herein, the term “connectionless” means the wireless nodes 101 need not use two-way signaling to establish a communication channel before broadcasting a message. In exemplary embodiments, the D2D radio layer 209 may include multiple radios using one or more different technologies or protocols (e.g., WLAN and Bluetooth® simultaneously). A wireless node 101 configured with multiple radios may act as a gateway node to span two or more sub-networks serviced by the different wireless technologies. In this way, messages broadcast on one sub-network may be propagated to another sub-network.

FIG. 2G is a diagram depicting a power saving scheme of a device-to-device radio layer, according to an exemplary embodiment. The small amount of awareness data as well as the low latency requirements of the system 100 enables the operation of the D2D radio layer 209 in a way that leads to low power consumption. As shown in FIG. 2G, the D2D radio layer 209 may have beaconing periods 291a-291c delineated by target beacon transmission times (TBTTs) 293a-293c. In exemplary embodiments, the D2D radio layer 209 may operate in a time-synchronized manner and utilize only a fraction of the time for active communication (e.g., during awake periods 295a-295c). During the rest of each beaconing period 291, the D2D radio layer 209 is in, for instance, a power-saving or dozing mode (e.g., during doze periods 297a-297c). For example, each beaconing period 291 can be on the order of hundreds of milliseconds and each awake period 293 only a few milliseconds, leading to effective radio utilization of approximately one percent. It is contemplated that for situations, where the number of wireless nodes 101 is very large (such as during mass events), time-wise radio utilization can increase up to 100 percent momentarily (e.g., awake period 293 equals active transmission period 291). At times of low traffic (for example at night), the radio utilization can be decreased to, for instance, 0.1 percent, by utilizing every tenth awake period 293 while still maintaining synchronization.

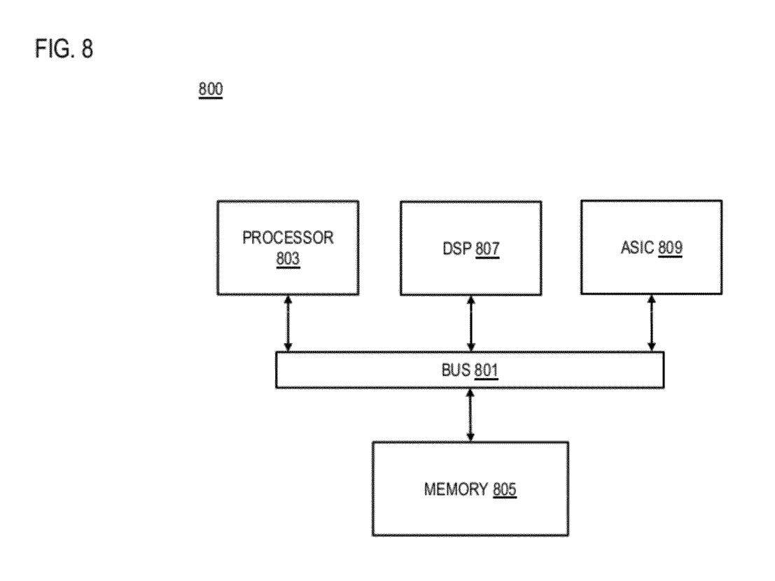

In exemplary embodiments, the low latency requirements also enable saving power in the host processor (e.g., as depicted in FIG. 8). For illustration, the following description refers to the components of exemplary chip set of FIG. 8. The D2D radio layer 209 is typically implemented in the ASIC module 809, whereas the functionalities of the awareness services module 111 can be implemented either in the ASIC 809 or the processor 803. If the functionalities of the awareness services module are implemented in the processor 803, power consumption is reduced by, for instance, having ASIC 809 wake up the processor 803 as infrequently as possible. By way of example, the periodic operation of the D2D radio layer 209 explained above enables the ASIC 809 to collect all messages and send them to the processor 903 at a frequency of once per active transmission period 291. The processor 803 then processes all received messages and calculates new messages to be sent for the next active transmission period 291. The processor 803 then sends the messages to the ASIC 809 for transmission. Using this process, a flooding message can make one hop (e.g., travel from one wireless node 101 to another wireless node 101) per period 291, which is fully acceptable for awareness information. In contrast, potential delays of hundreds of milliseconds are not possible, for example, for voice traffic, and these kinds of power savings cannot therefore be achieved in other communication systems transporting delay-sensitive traffic.

The above described power saving mechanisms may be performed by wireless nodes 101 on an individual or group basis. By way of example, wireless nodes 101a-101n may execute the above mentioned power saving procedures based on a load sharing scheme. The scheme may, in certain embodiments, be a function of the determined depth or width of a hierarchy representative of a location anchor. In certain embodiments, the depth and/or width may further correspond to a size of the hierarchy, and thus, a size of the number of wireless nodes 101 participating in a communication session with other wireless nodes 101 relative to a location anchor.

It is noted that the size of the hierarchy may also correlate to or represent a level of activity information, popularity, or relevancy of a activity information relative to a location anchor. For example, a rapid pace or volume of joining of wireless nodes 101 to a particular location anchor where a virtual game is taking place may indicate a highly popular (viral) response to the game. The number of remote and/or locally connected wireless nodes 101 may also be considered for ascertaining the overall geographic and thus market viability and potential of the game. As another example, a large volume of activity information among multiple nodes relative to a location anchor corresponding to an airport where emergency measures have occurred may be corroborated by monitoring the volume of messages and/or increase in the number of wireless nodes 101 engaging in social networking to discuss the situation (e.g., an explosive threat). While the content of the messages need not be analyzed, the increased message activity may be compared against available information regarding the location anchor (e.g., news feed data, traffic reports) as a means of validation.

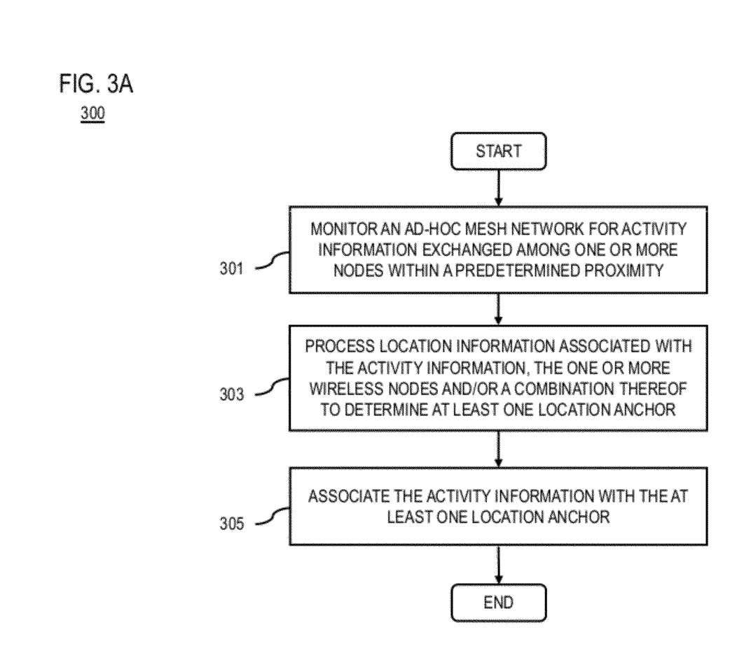

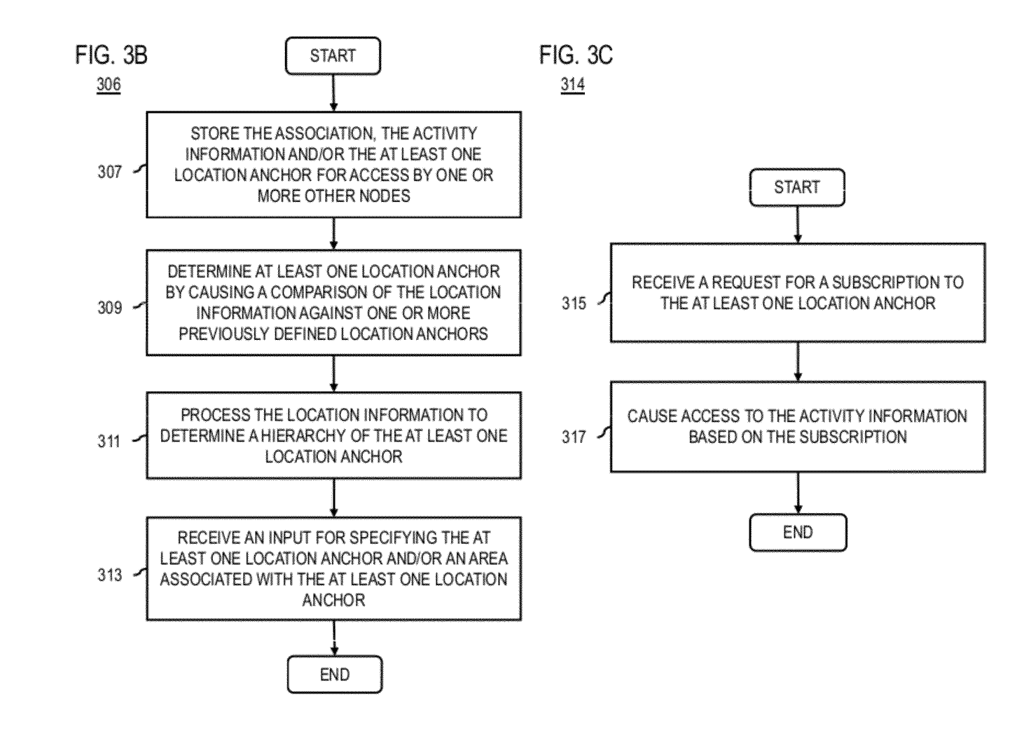

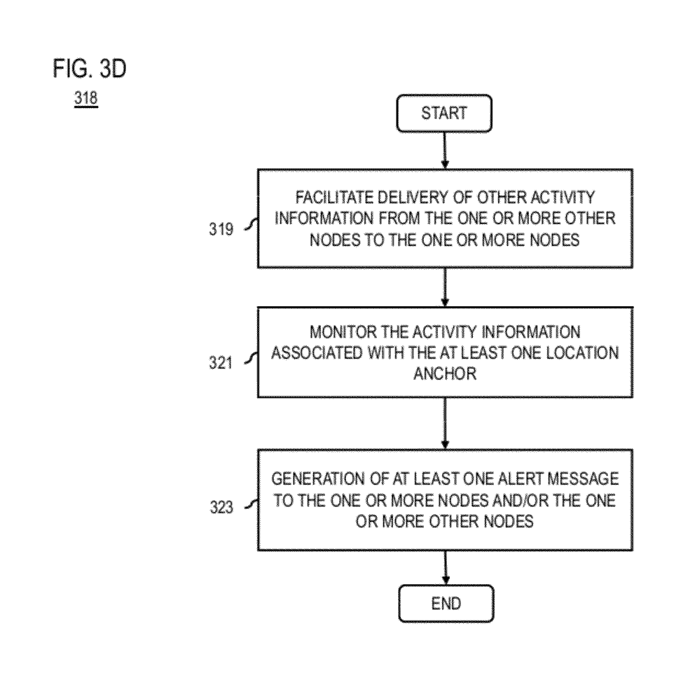

FIGS. 3A-3D are flowcharts of processes for enabling location based interaction between wireless nodes over an ad-hoc mesh network, according to various exemplary embodiments. In one embodiment, the location anchor service platform 115 operates in connection with the LASM 113 and/or awareness services module 111 to perform processes 300, 306, 314 and 318 of FIGS. 3A-3D respectively. The processed are implemented in, for instance, a chip set including a processor and a memory as shown in FIG. 8.

In a first step 301 of process 300 (FIG. 3A), the LASM 113 monitors an ad-hoc mesh network for activity information exchanged among one or more nodes within a predetermined proximity. As mentioned previously, the activity information may be related to a mutual activity or interaction between the one or more nodes, including a gaming activity, social networking activity, information exchange activity, meeting activity or the like. In another step 303, the LASM 113 processes location information associated with the activity information, the one or more wireless nodes and/or a combination thereof to determine at least one location anchor. Per step 305, the location anchor is associated with the activity information, including substantially real-time messages, one or more historical messages, or a combination thereof. As noted previously, this association enables the messages to be further recorded by the LASM 113 with respect to other messages related to the same location.

For FIG. 3B, in step 307 of process 306, the LASM 113 store the association (of the anchor with the messages), the activity information and/or the at least one location anchor for access by one or more other wireless nodes 101. In certain embodiments, the one or more other wireless nodes 101 may include both local or remotely connected wireless nodes 101 wanting to join an activity. In another step 309, the LASM 113 determines the at least one location anchor, per step 303 of FIG. 3A, by causing a comparison of the location information against one or more previously defined location anchors. In instances where no match is determined, a new location anchor may be defined and stored as anchor data. One or more data tagging or metadata generation techniques may be employed for defining or naming the location anchor accordingly.

In step 311, the LASM 113 and/or location anchor service platform 115 process the location information to determine a hierarchy of the at least one location anchor. As noted, the hierarchy information may correspond to a scale of activity associated with the location anchor. Per step 313, the LASM 113 and/or location anchor service platform 115 may receive an input for specifying the at least one location anchor and/or an area associated with the at least one location anchor. It is also contemplated that user defined input or available user data may be accepted for defining a location anchor. By way of example, in response to a newly determined location anchor, the user may be prompted to enter a name of the anchor or provided with a suggestion based on mapping data or social networking/contact management data available to the user. In another example, an existing location anchor may be updated based on the determination of relevant location information for substantiating a correction.

For FIG. 3C, for step 315 of process 314, the LASM 113 and/or the location anchor service platform 115 receive a request for a subscription to the at least one location anchor. By way of example, a local wireless node 101a-101n or remote wireless node 101r may wish to engage in an activity determined to be associated with a particular location anchor. To engage in the activity, the node submits a request to join in on the activity, which in turn causes access by the node to the activity information based on the subscription per step 317. When the subscribing node is within a predetermined proximity/range of the ad-hoc mesh network 109, the LASM 113 facilitates the registration and access process. When the node is located remotely, access to the activity information related to the activity is facilitated by way of the location anchor service platform 115. As noted, the location anchor service platform 115 serves as an intermediary service for enabling remote wireless node 101r engagement with ad-hoc network connected wireless nodes 101a-101n in the common activity/location anchor. In certain embodiments, the location anchor service platform 115 is implemented as a hosted solution or cloud computing based application.

For FIG. 3D, in step 319 of process 318, the location anchor service platform 115 determines to facilitate delivery of activity information from the one or more other wireless nodes 101 to the one or more nodes. This corresponds to the two way function of the location anchor service platform 115, which ensures that messages by remote wireless nodes 101r are monitored and recorded by the LASM 113 for facilitating remote-to-local interaction at a given location anchor. In another step 321, the location anchor service platform 115 and/or LASM 113 monitor the activity information associated with the at least one location anchor. As noted previously, the monitoring may be performed for determining a scale of activity associated with the location anchor or other factors. Per step 323, the location anchor service platform 115 and/or LASM 113 generates at least one alert message to the one or more nodes and/or one or more other wireless nodes 101. This may be performed in response to the monitoring. For example, a message for indicating a change message exchange between one or more nodes may be sent to the nodes as an alert (e.g., loss of players in a game).

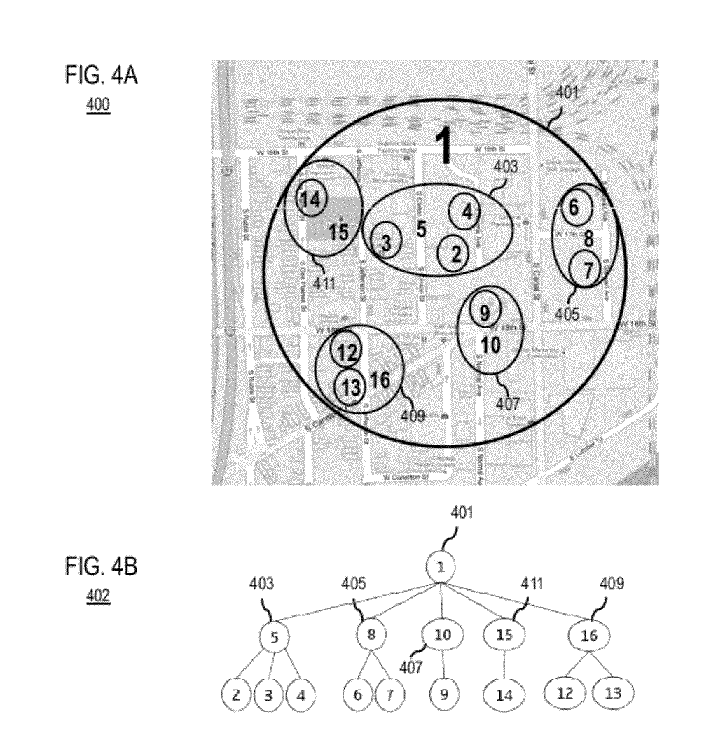

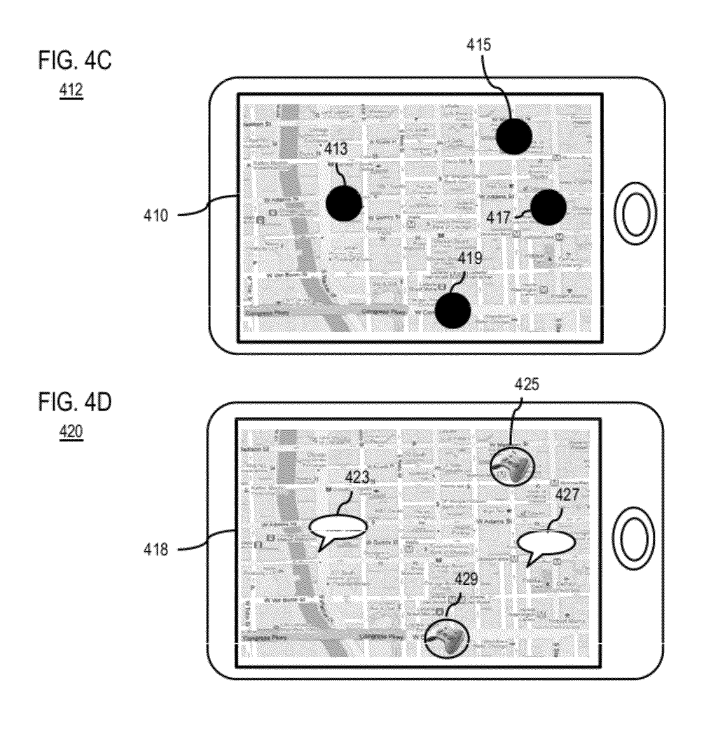

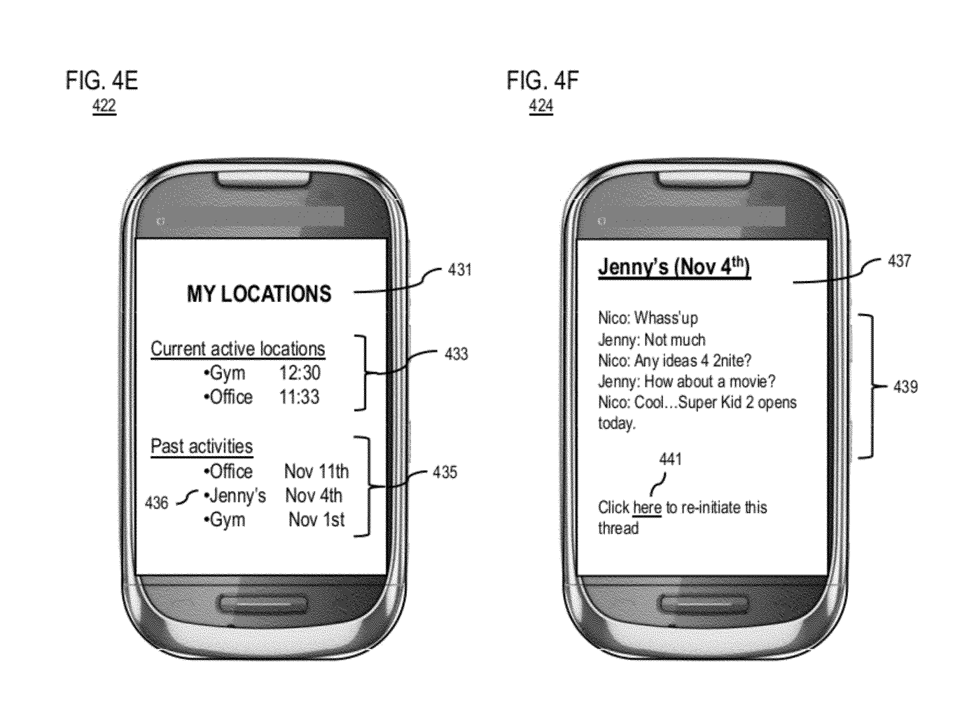

FIGS. 4A and 4F are diagrams of a user interfaces utilized in the process of enabling location based interaction between wireless nodes over an ad-hoc mesh network, according to various exemplary embodiments. For the purpose of illustration, the interfaces are described with respect to exemplary use-case scenarios pertaining to the use of awareness information in connection with one or more location anchors or applications thereof.

In FIG. 4A, a number of wireless nodes are shown relative to a map 400 as they are engaged in a locally based activity over an ad-hoc mesh network. Per the LASM 113 and/or the location anchor service platform 115, the nodes are presented as location anchors (Las) or location points (lower granularity Las) 1-16 against the map 400. The LAs are also presented in equivalent hierarchical form 402 with respect to FIG. 4B, which illustrates the depth, width and therefore scope of the conglomeration of anchors 1-16. It is noted in certain embodiments that a user interface of a wireless node may be caused to display either the map 400 based and/or hierarchical 402 based view of the various engaged 1-16 nodes within the ad-hoc mesh network.

By way of example, when more than one location point are clustered in a particular location anchor (e.g., LA 14) that has reached its maximum size, another location anchor (e.g., LA 15) is generated and the two location anchors are grouped together as LA 411 while keeping their original information. By analogy, LAs labeled 401, 403, 405, 407 and 409 corresponding to LAs 1, 5, 8, 10 and 16 respectively, are formed by grouping the respective LAs 2-14. Based on this relationship between wireless nodes 101a-101n, the LA hierarchical structure of FIG. 4B is represented as a three-tier tree structure 402, where at the highest level of hierarchical extraction is LA 1; the second level of extraction featuring LAs 5, 8, 10, 15, and 16; and the third level of extraction represented by 2, 3, 4, 6, 7, 9, 14, 12 and 13. Each level of extraction corresponds to a level of granularity of location information as well as an extent of scaling of a given location anchor. Hence, according to the non-hierarchical approach, the conglomeration of LAs 2-16, at various levels of depth, becomes a single encompassing location anchor (LA 1) after a period of time of additional wireless nodes. Hence, if at the lowest tier of FIG. 4B, the various LAs are scaled at a building/office level of granularity (e.g., Dean Johnson's Office), the highest tier (LA 1) represents a full area (e.g., an entire college campus). Under this approach, a user may view top-level and sub-level location anchors.

In another example with respect to FIG. 4A, at a time point t1, all of the nodes represented to the map as LAs 1-16 detected to be engaged in the activity are within the geographic reach of LA 2. Per execution of the processes of FIGS. 3A-3D, this location anchor is determined to sufficiently represent the activity. However, at a later time t2, a new wireless node joins the network, based from LA 4. At this point, since the geographic reach of the associated activity has expanded the LASM 113 and/or the location anchor service platform 115 scales up to the level of LA 5. This location anchor provides a more accurate representation of the geographic reach of the local activity, and is stored as such to the anchor database 121. At yet another time t3, a few more nodes join the ad-hoc network in order to engage in location based activities based from LA 15 and LA 8. Resultantly, yet another level of scaling up is performed by the LASM 113 but this time to the level of LA 1.

Hence, it is noted in the above described examples that the scaling activity is performed in response to the expansion/compression of one or more related wireless nodes relative to a particular local environment. This includes an increased or decreased node volume, increased/decreased rate of joining, and other factors.

FIGS. 4C and 4D depict various modes of presentment of location anchors at participating wireless nodes. By way of example, map based user interfaces 410 and 418 corresponding to FIGS. 4C and 4D respectively are presented to the display of wireless nodes in the form of mobile devices 412 and 420. For mobile device 412, multiple location points 413-419 are presented in accordance with a given activity against map information. In this example, the icons 413-419 do not provide a direct indication of the type of activity associated with the location anchor. For device 420, however, the same map based user interface is presented with icons for indicating the type of activity information that is directly associated with the anchor. By way of example, the chat box icon 423 and 427 indicate social networking activities occurring with respect to those location anchors, while the game controller icons 425 and 429 indicate gaming activities occurring with respect to those location anchors.

It is noted that end users subscribed to a particular location anchor can access the ongoing, local activity in real-time as content pertaining to a particular activity. The iconography can be customized to correlate to different types of activities relative to a given location anchor, including parties, sales events, natural disasters, accidents, meetings, concerts, etc. In certain embodiments, the iconography may also be customized for specific roles and functions of wireless node users, such as based on organizational chart title, department, function, etc.

In another embodiment, the user can receive a text based notification at a wireless node should a location anchor they are subscribed to becomes associated with locally based activities. This corresponds to instances wherein a location anchor is generated for the first time or is not able to be associated with any pre-existing location anchors.

In another embodiment, participation by remotely situated nodes can take place synchronously, while the interaction is active locally, or asynchronously. This interaction by remote wireless nodes 101 occurs once the synchronous, locally based interaction is completed by the various participating nodes. FIGS. 4E and 4F depict user interfaces 422 and 424 of a wireless device 422 for enabling the presentment of synchronous and asynchronous activity, engagement, respectively. By way of example, in FIG. 4E, the user is presented with a listing of currently active locations 433 and past activities 435 to which a particular location was anchored. The user may access a past activity by double clicking on the activity of interest. When the user selects the “Jenny's” link 436, a reconstruction of the past activity (that occurred at a previous data of November 4^{th}) is displayed to the screen 437 as shown in FIG. 4F. In this example, the past activity pertains to a social networking activity and is therefore a chat thread 439 that occurred between the user and their friend Jenny. The user is presented with a link 441 for reinitiating the thread by posting a new note.

It is noted that the identity of the wireless nodes (e.g., mobile devices 422 and 424) engaged in the local activity is recorded and uploaded by the LASM 113 enabled nodes. This enables owners of the respective wireless nodes to access the activity in retrospect, i.e., should the activity be restricted from the general public view via subscribers to the ad-hoc network or location anchor service platform 115. By way of this approach, the provider of the location anchor service platform 115 and LASM 113 is able to send information, such as notifications, to nodes in retrospect. For example, a notice may be transmitted to Jenny's wireless node to indicate that a user, Nico, wants to restart the November 4^{th} social networking activity as depicted in FIG. 4F. The ability to reinitiate a past activity based anchor is possible due to the persistent two-way uploading and downloading of information between the location anchor service platform 115 and the LASM 113 as they record messages generated by remote wireless nodes 101 and local wireless nodes 101 concurrently. As mentioned, the LASM 113 enabled nodes engaged in locally based activities are not only uploading the locally based activities to the platform 11, but downloading information created by remote participants and feeding in this information to the terminals engaged in the local activity.

As another exemplary use case with respect to FIG. 4F, the reinitiating of a past location based activity is not limited to only those wireless nodes and thus users actively engaged in the original activity. For example, when the user Nic and Jenny finish the November 4^{th} social networking session and exit the location anchor 436 to which the activity was tied, this data is recorded accordingly by the LASM 113. At a later time/date, another user may access the chat thread 439 locally via the LASM 113 or by way of the location anchor service platform 115 if they are remotely positioned. By selecting link 441, this user may then write a new post to the thread 439, thereby re-initiating the locally based thread. Resultantly, Jenny and Nico receive a text message based notification indicating that new content associated with the November 4^{th} social networking activity has been posted.

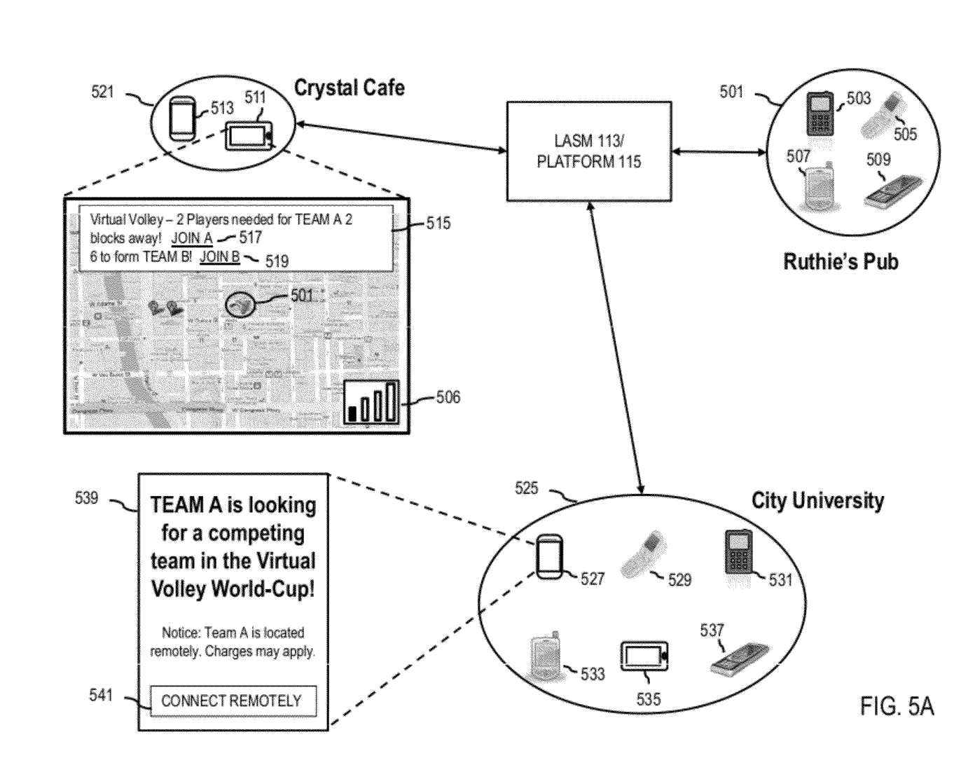

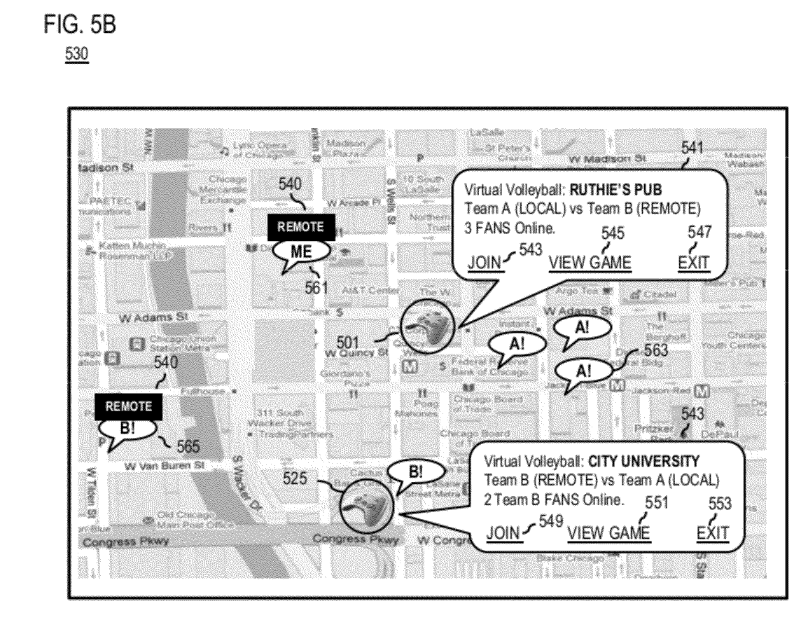

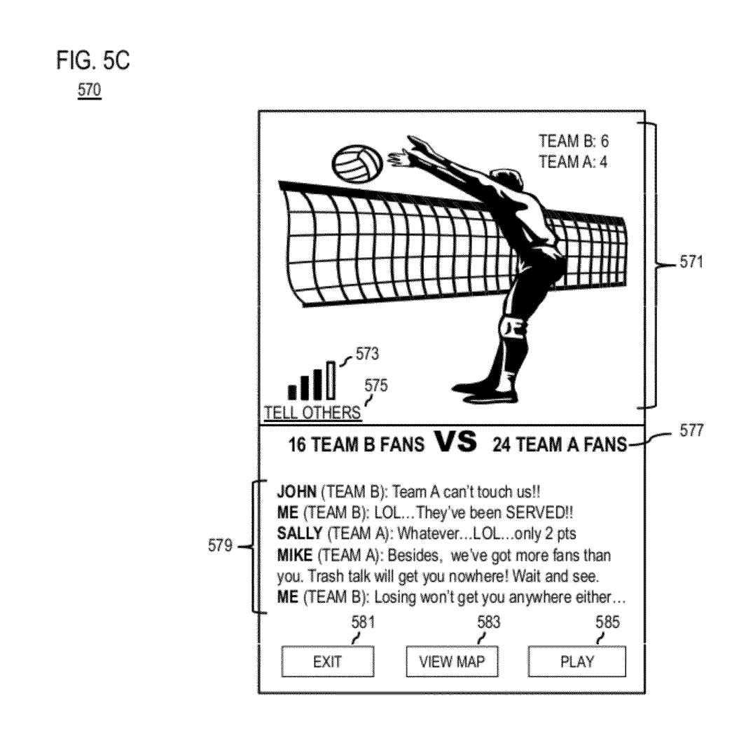

FIGS. 5A-5C are diagrams depicting a flowchart of a process for providing access for broadcasting flooding message and sharing information anonymously, according to an exemplary embodiment. For the purpose of illustration, the diagrams are presented from the perspective of various exemplary use cases pertaining to the use of awareness information in connection with one or more location anchors or applications thereof.

In a first use case per FIG. 5A, users A, B, C and D operate wireless nodes 503-509 respectively. The users are all located in the same place 501, corresponding to location anchor reference “Ruthie's Pub.” At least one of the wireless nodes 503-509 is LASM 113 enabled, and each node is capable of generating and exchanging awareness information. They decide to play a volleyball videogame named “Virtual Volley,” a 6-on-6 player game. Each user launches the game application and the locally based interaction is determined by way of the awareness services module 111 running on each node. As a multi-player game for execution within the ad-hoc network (local interaction), they have the option of synchronizing their activities for enabling the interaction, i.e., viewing the same interface, viewing the real-time actions of the other players, etc.

When the game starts, the users sign up as players of Team A for the “World-Cup” game. As the game application is LASM 113 enabled, a message is broadcast to other wireless nodes within proximity of the ad-hoc mesh network 109 as well as remote users via the location anchor service platform 115. The message is presented as an announcement 515 to the various wireless nodes 101 that there are 2 vacancies on the Team A roster and 6 vacancies for a competing Team B. The announcement 515 includes links 517 and 519 respectively for enabling a recipient to opt to join Team A or Team B respectively. The announcement may also include relative location, distance or directional information for the location anchor Ruthie's Pub 501 serving as the epicenter of activity.

Recipients of the message include Users E and F, who operate wireless nodes 511 and 513 respectively. They receive the message as they are having a coffee at Crystal Café, a location anchor 521 referencing a café near Ruthie's Pub 501. As the default setting for one of the wireless nodes 511 is an interactive map view, i.e., as in FIGS. 4C-4D, Users E and F are able to observe the relative short distance from Crystal Café 521 to Ruthie's Pub 501, and to walk to the location anchor 501. An indicator 506 for representing the scaling, popularity, or intensity of interaction at the primary location anchor 501 is also shown, which at the present moment is not significant as few wireless nodes 101 have registered for the particular location based activity. Nonetheless, Users E and F opt to Join Team A, resulting in a notification being sent to the other players and a map view being presented to wireless nodes 503-509 showing the impending arrival of Users E and F.

Meanwhile, a student at a university whose campus is referenced by location anchor City University 525 decides to launch the same Virtual Volley application via their phone (e.g., wireless node) 527. Upon launch and entry as a player on Team B by the student, the LASM 113/the location anchor service platform 115 advertises 5 vacant places in location anchor City University 525. Soon, five other students with awareness capable nodes 529-537 also join the game, and they form Team B. Each of the nodes 527-537 receive an announcement 539 from the LASM 113/location anchor service platform 115 notifying them there is a “World-Cup” game ready to start and a team is needed to compete. Although they are out of local proximity to Team A, the students of Team B decide to challenge remotely challenge Team A to compete in the World-Cup by selecting a “Connect Remotely” action button 541. It is noted that the announcement indicates that data and/or cellular phone charges may apply if a remote connection is established.

When the game starts, the coordination of each team member is managed by LASM 113 locally and the cellular link is used to coordinate the remote connection between the two teams. Assuming the amount of data needed to be transmitted to coordinate the remote connection of the game between the two teams is constant (in fact if a team lacks some human players they are replaced by some ones generated by the game), each team shares the load of the cellular bandwidth of any given individual's device. This creates an incentive to form a community, such that when more players join, the individual load is less for the cellular link (remote connectivity manager 119) of the location anchor service platform 115. As a consequence, the energy consumption of the device is optimized during game play. Uploading less over the cellular connection also results in less data transfer charges.

With reference to FIG. 5B, a remote user launches the same application and eventually receives a map viewing 530 indicating the current World-Cup activity. The viewing 540 presents, for example, various location anchors as icons 501 and 525 for representing the current gaming activities among Team A and Team B respectively. In addition, multiple chat icons 563 and 565 are presented as location anchors for representing social networking/chat activities occurring with respect to the World Cup activity. By way of example, icons 563 represent location anchors pertaining to fans/spectators of Team A who wish to engage in a virtual fan chat. Icons 564 represent location anchors pertaining to fans/spectators of Team B, some of which are remotely located as indicated by a REMOTE icon 540. In addition, an icon for representing the user 561 is presented.

A callout view 541 and 543 are also featured with respect to the icons 501 and 525 respectively for providing the remote user with details of the activity. In certain embodiments, the callout views 541 and 543 are activated based on mouse-over or click action by the user. Details provided in the respective callout views 541 and 543 may include a reference to the specific location anchors Ruthie's Pub 501 and City University 525, the name of the current activity, the team name and whether it is within proximity (local) or out of a predetermined proximity (remote) to the viewing user and a number of fans currently engaged to view the match. With respect to the user referenced by location anchor 561, Team A is local while Team B is remote. The callout view 541 and 543 also includes various action buttons for enabling the user to engage or disengage in a particular location anchor activity, including a “Join” action button 543/549 for joining the activity as a fan of a particular team, a “View Game” action button 545/551 for simply viewing the game and an “Exit” action button 547/553 for exiting.

Given that Team B has less fans and that Team B represents the user's alma mater, the user selects the “Join” action button 549 within the callout view 543 for Team B. This results in an alert being sent to the various other fans via the location anchor service platform 115/LASM 113 that another fan has joined, a refreshing of the indicated number of fans online per respective callout views 541 and 543, and addition of a REMOTE icon 540 above the location anchor 561 of the user for indicating remote connectivity. In addition, the chat and game viewer respective to the Virtual Volley application is presented to the user interface, as shown in FIG. 5C.

Per FIG. 5C, the chat and game viewer 570 allows for simultaneous viewing of the current volleyball match between Team A and B and chat messaging. As such, users subscribed to the location of the activity may engage in location based social networking. The game viewing section 571 presents the current match play as well as current score information for respective teams. Also presented is the current chat thread 579, which features the various conversations occurring between the various fans of Team A and Team B. Still further, an indicator 573 for representing the scaling, popularity, or intensity of interaction at the primary location anchor 501 is shown. It is noted that the value represented by the indicator 573 is higher than it was in FIG. 5A. By way of example, the value has risen as a result of the increase in subscribers to the location anchor representing the gaming activity (e.g., an area now encompassing all of the fans, Team A and Team B); for which now 16 Team B fans and 24 Team A fans are participants, as indicated by a fan score 577.

The fans may post their comments which get stored by the LASM 113 and/or location anchor service platform 115 accordingly. Hence, the entire thread 579 can be stored to the location anchor service platform 115 and retrieved for later review by another wireless node that was not part of the original conversation. An “Exit,” “View Map” and “Play” button are also featured for enabling the user to exit the chat and game viewer 570, go back to the virtual map view (e.g., FIG. 5B) or be placed in a queue to play next, respectively.

Of note, the scaling indicator 573 may indicate a level of activity information among the one or more nodes, a level of shared power consumption among the one or more nodes, or combination thereof. By selecting the “TELL OTHERS” link 575 respective to the indicator 573, users engaged in an activity associated with the location anchor may transmit a message to others within their social network to encourage them to participate in the location anchor. When more players join, the individual load per wireless node 101 is less for sustaining the cellular link—i.e., the remote connectivity link—and the indicator 573 scales up.

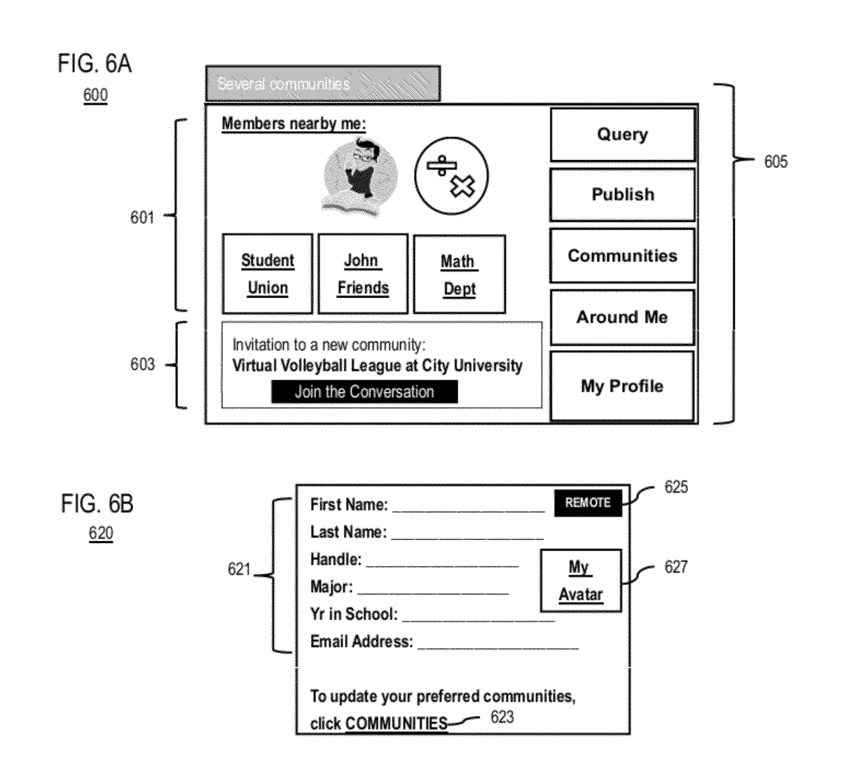

FIGS. 6A-6B are diagrams of a user interface utilized in the process of providing awareness information over an ad-hoc mesh network, according to various exemplary embodiments. For example purposes, FIG. 6A depicts a user interface 600 listing community related information and commands for managing and accessing awareness information within a university. Under this scenario, the awareness services module 111 on the mobile devices of university students mediates a locally based social networking service made available to community members (e.g., students, staff, teachers), wherein students who are currently on the campus can locally engage in social networking. The service allows the students to update their profiles, check who's around, exchange messages between other members, etc.

For example, section 601 lists community members who are nearby the wireless node 101. The members may be from one or more different communities. Selecting a member enables a user to contact the member, view the status of the member, or access other applications or functions related to the user. Section 603 may display, for instance, status commands or prompts such as an invitation to join a particular community. User interface 600 also provides selectable menu options 605 to initiate additional commands, including an “Around Me” option for viewing maps of the area or a “My Profile” option for updating or establishing a profile. Any students with devices having LASM capability can upload profile information as well as public conversations to the location anchor service platform 115. This way, students who are not presently on campus can still follow locally held conversations in real-time as they occur among students who are on campus. The remotely located participants can also post messages and update their profiles accordingly.

For example, when a remote user selects the “My Profile” action button, a profile configuration view 620 is shown per FIG. 6B. The user is presented with various data entry fields 621 for entering details regarding their name, degree of study and contact information. The user may also update their avatar by selecting the “My Avatar” link 627.

Another section also features a link 623 for enabling the user to transition their display to a community configuration view, wherein they may update their preferred communities. For example, a user who is an avid recreational volleyball player may opt to select the “Virtual Volleyball League at City University” as their default or preferred community from among many other options. As another example of the community settings, users may also designate each community as either public or private, activate or deactivate certain communities, select or deselect certain members to interact with, etc.

In the foregoing example, the user is able to perform the above described actions remotely in the same manner as would a local community member participant. However, because the user is remotely accessing the location anchor service platform 115, their profile page 620 includes an icon 625 for signifying that they are participating in the service remotely.

The processes described herein for enabling location based interaction between wireless nodes over an ad-hoc mesh network may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

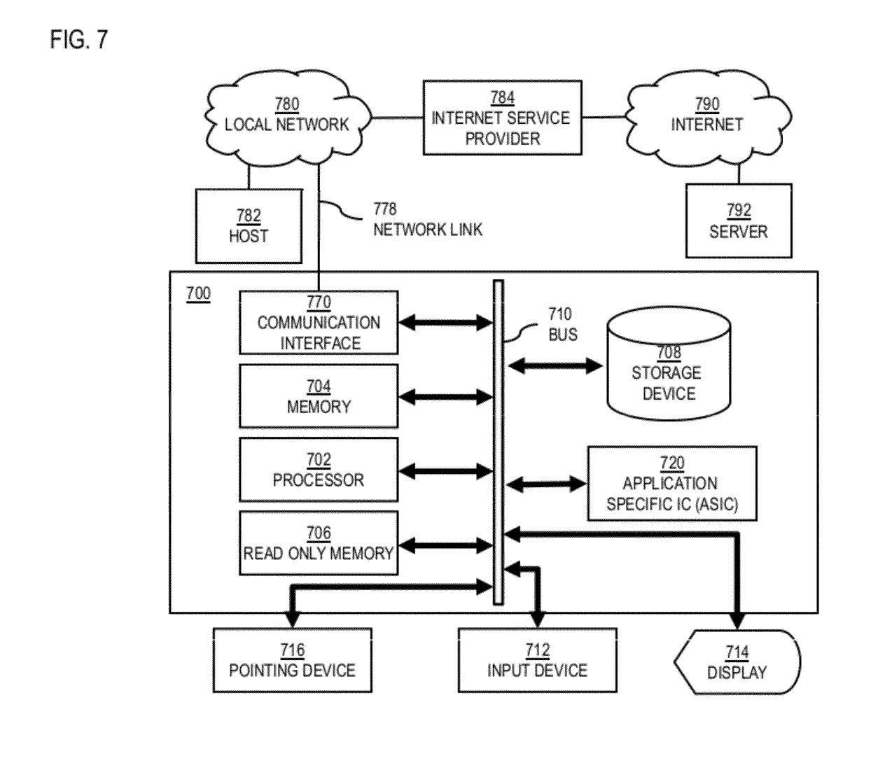

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to enable location based interaction between wireless nodes over an ad-hoc mesh network as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of enabling location based interaction between wireless nodes over an ad-hoc mesh network.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to enable location based interaction between wireless nodes over an ad-hoc mesh network. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for enabling location based interaction between wireless nodes over an ad-hoc mesh network. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for enabling location based interaction between wireless nodes over an ad-hoc mesh network, is provided to the bus 710 for use by the processor from an external input device 712, such as a keyboard containing alphanumeric keys operated by a human user, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for enabling location based interaction between wireless nodes over an ad-hoc mesh network to the wireless node 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to enable location based interaction between wireless nodes over an ad-hoc mesh network as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of providing user interface navigation information associated with the availability of functions. Chip set or chip 800, or a portion thereof, constitutes a means for performing one or more steps of enabling location based interaction between wireless nodes over an ad-hoc mesh network.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to enable location based interaction between wireless nodes over an ad-hoc mesh network. The memory 805 also stores the data associated with or generated by the execution of the inventive steps.

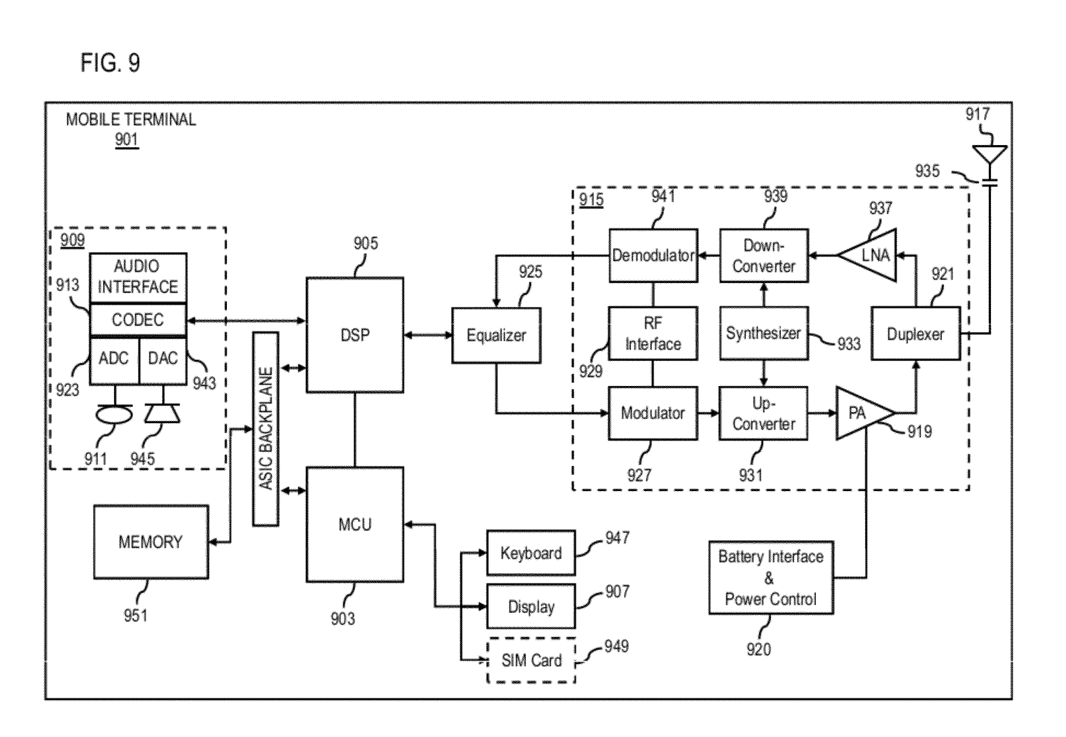

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of enabling location based interaction between wireless nodes over an ad-hoc mesh network. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of enabling location based interaction between wireless nodes over an ad-hoc mesh network. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU) (not shown).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to enable location based interaction between wireless nodes over an ad-hoc mesh network. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
a monitoring of an ad-hoc mesh network for activity information exchanged among one or more nodes within a predetermined proximity;
a processing of location information associated with the activity information, the one or more wireless nodes, or a combination thereof to determine at least one location anchor; and
an association of the activity information with the at least one location anchor.

2. A method of claim 1, wherein the (1) data and/or (2) information and/or (3) at least one signal are further based, at least in part, on the following:
a storage of the association, the activity information, the at least one location anchor, or a combination thereof for access by one or more other nodes,
wherein the one or more other nodes are beyond the predetermined proximity, beyond a range of the ad-hoc mesh network, or a combination thereof.

3. A method of claim 2, wherein the (1) data and/or (2) information and/or (3) at least one signal are further based, at least in part, on the following:
a determination to facilitate delivery of other activity information from the one or more other nodes to the one or more nodes,
wherein the other activity information originates, at least in part, in a communication network other than the ad-hoc mesh network and terminates, at least in part, in the ad-hoc mesh network.

4. A method of claim 2, wherein the (1) data and/or (2) information and/or (3) at least one signal are further based, at least in part, on the following:
a monitoring of the activity information associated with the at least one location anchor; and
a processing of the monitoring to cause, at least in part, a generation of at least one alert message to the one or more nodes, the one or more other nodes, or a combination thereof.

5. A method of claim 2, wherein access to the storage is by a communication network other than the ad-hoc mesh network.

6. A method of claim 1, wherein the (1) data and/or (2) information and/or (3) at least one signal are further based, at least in part, on the following:
a determination of the at least one location anchor by causing, at least in part, a comparison of the location information against one or more previously defined location anchors.

7. A method of claim 1, wherein the (1) data and/or (2) information and/or (3) at least one signal are further based, at least in part, on the following:
a processing of the location information to determine a hierarchy of the at least one location anchor,
wherein the association is further based, at least in part, on the hierarchy and the hierarchy indicates a scale of activity associated with the at least one location anchor.

8. A method of claim 1, wherein the (1) data and/or (2) information and/or (3) at least one signal are further based, at least in part, on the following:
an input for specifying the at least one location anchor, an area associated with the at least one location anchor, or a combination thereof.

9. A method of claim 1, wherein the (1) data and/or (2) information and/or (3) at least one signal are further based, at least in part, on the following:
a request for a subscription to the at least one location anchor; and
an access to the activity information based, at least in part, on the subscription.

10. A method of claim 1, wherein the activity information include, at least in part, one or more at least substantially real-time messages, one or more historical messages, or a combination thereof.

11. An apparatus comprising:
at least one processor; and
at least one memory including computer program code for one or more programs, the at least one memory and the computer program code configured to, with the at least one processor, cause the apparatus to perform at least the following,
cause, at least in part, a monitoring of an ad-hoc mesh network for activity information exchanged among one or more nodes within a predetermined proximity;
process and/or facilitate a processing of location information associated with the activity information, the one or more wireless nodes, or a combination thereof to determine at least one location anchor; and
cause, at least in part, an association of the activity information with the at least one location anchor.

12. An apparatus of claim 11, wherein the apparatus is further caused to:
cause, at least in part, a storage of the association, the activity information, the at least one location anchor, or a combination thereof for access by one or more other nodes,
wherein the one or more other nodes are beyond the predetermined proximity, beyond a range of the ad-hoc mesh network, or a combination thereof.

13. An apparatus of claim 12, wherein the apparatus is further caused to:
determine to facilitate delivery of other activity information from the one or more other nodes to the one or more nodes,
wherein the other activity information originates, at least in part, in a communication network other than the ad-hoc mesh network and terminates, at least in part, in the ad-hoc mesh network.

14. An apparatus of claim 12, wherein the apparatus is further caused to:
cause, at least in part, a monitoring of the activity information associated with the at least one location anchor; and
process and/or facilitate a processing of the monitoring to cause, at least in part, a generation of at least one alert message to the one or more nodes, the one or more other nodes, or a combination thereof.

15. An apparatus of claim 12, wherein access to the storage is by a communication network other than the ad-hoc mesh network.

16. An apparatus of claim 11, wherein the apparatus is further caused to:
determine the at least one location anchor by causing, at least in part, a comparison of the location information against one or more previously defined location anchors.

17. An apparatus of claim 11, wherein the apparatus is further caused to:
process and/or facilitate a processing of the location information to determine a hierarchy of the at least one location anchor,
wherein the association is further based, at least in part, on the hierarchy and the hierarchy indicates a scale of activity associated with the at least one location anchor.

18. An apparatus of claim 11, wherein the apparatus is further caused to:
receive an input for specifying the at least one location anchor, an area associated with the at least one location anchor, or a combination thereof.

19. An apparatus of claim 11, wherein the apparatus is further caused to:
receive a request for a subscription to the at least one location anchor; and
cause, at least in part, an access to the activity information based, at least in part, on the subscription.

20. An apparatus of claim 11, wherein the activity information include, at least in part, one or more at least substantially real-time messages, one or more historical messages, or a combination thereof.
